(19) United States
(12) Patent Application Publication
(10) Pub. No.: US 2024/0231814 A9
(43) Pub. Date: Jul. 11, 2024

(54) SCANNING APPLICATION CODE TO DETECT AND CLASSIFY SDK DATA INTO DATA CATEGORIES

(71) Applicant: OneTrust LLC, Atlanta, GA (US)

(72) Inventors: Jake Kiermasz, Bristol (GB); Julian Evans, Huntingdon (GB)

(21) Appl. No.: 18/490,344

(22) Filed: Oct. 19, 2023

Related U.S. Application Data
(60) Provisional application No. 63/380,334, filed on Oct. 20, 2022.

(51) Int. Cl. G06F 8/75

(52) U.S. Cl. CPC G06F 8/75

(57) ABSTRACT

This disclosure describes some aspects of systems, non-transitory computer-readable media, and computer-implemented methods that generate insightful user interfaces that display data processing activity components from the application codes, data categories for the detected components, and/or modifications of data categories and/or data processing activity components. For example, the disclosed system can utilize the application code scan to categorize one or more data types and/or data processing purposes represented by the various detected data processing activity components. Additionally, the disclosed systems can generate dynamic graphical user interfaces with the data processing activity components and data categories to enable quick and insightful access to a wide breadth of information from an application code scan. Moreover, the disclosed systems can also determine (and display) changes of data processing activity components and/or data categories detected between scans of different versions of the application code.

### CROSS-REFERENCE TO RELATED APPLICATIONS

This application claims priority to, and the benefit of, U.S. Provisional Patent Application No. 63/380,334, filed on Oct. 20, 2022, which is incorporated herein by reference in its entirety.

### BACKGROUND

Recent years have seen an increasing implementation of computer systems that implement scanning tools to detect functions in application code. Specifically, many entities increasingly utilize scanning tools to analyze source code of an application to identify data processing activities performed by an application. Indeed, such scanning tools are often utilized to identify tracking technologies used by websites and applications. For example, application store platforms (e.g., platforms that deploy applications to various users) often utilize scanning tools and/or manual review to identify tracking technologies (or other data processing activities) present in an application code prior to distributing the application. While scanning tools exist to analyze source code of an application, existing scanning tools are often limited in insight, often result in convoluted outputs (especially when an application source code contains a large number of data processing activities), and often result in UIs and outputs that are difficult to navigate.

To illustrate, many systems receive (or analyze) application codes that are large in size (e.g., thousands of lines of code, tens of thousands of lines of code) and often reference various internal and imported libraries, call functions, and data types. In many cases, the application codes often utilize different coding styles, coding languages, syntax, and semantics such that it is difficult to analyze the referenced libraries, call functions, and data types. Accordingly, many existing scanning tools are only capable of detecting and outputting limited information from application code. Often, existing scanning tools generate simple and unintelligent outputs that simply list components in the application code (e.g., identified libraries, call functions, data type references).

In addition, due to the size of many application codes, many conventional code scanning tools result in convoluted output data. For instance, by simply listing various components present within an application code that may include thousands or millions of lines of code, many existing scanning tools output a substantially large list of components. In addition, existing code scanning tools often present components by listing the language utilized in the application code for the components (e.g., a specific SDK library syntax, a call function syntax). This often results in a large list (e.g., thousands) of specific references or calls present in the application code (in an unedited syntax) that are difficult to comprehend and/or meaningfully utilize.

Moreover, conventional code scanning tools are also often difficult (and inefficient) to navigate. Indeed, in many cases, existing code scanning tools result in inefficient user interfaces that are difficult to navigate. To illustrate, many conventional code scanning tools result in a substantially large list of output, detected components. In many cases, such large lists of components are inefficiently listed in a UI by conventional code scanners. As such, conventional code scanning tools often result in UIs that require many navigational steps to review large lists of components. In addition to not easily presenting the breadth of information detected from large application codes within compact UIs, many existing scanning tools also require additional navigation to comprehend the scan results (or listed components). For instance, oftentimes, the existing scanning tool lists components detected within an application code and require users to inefficiently navigate between various libraires and/or search engines to determine the listed components (and the components' purpose).

In addition to the foregoing, recent surges in data usage has introduced complex challenges for large organizations, particularly concerning data sprawl, which poses significant risks to data security and privacy. Data sprawl, in this context, pertains to the proliferation of independent software applications that handle and store data, including sensitive or personal information. This proliferation makes it challenging to monitor what software applications are tracking what data and the usage of data by software applications, thereby elevating the risk of data breaches and security incidents. One contributor to data sprawl is not knowing what data is being tracked or shared by SDKs of a software application. This is often the result of existing scanning tools providing results that are difficult to comprehend, navigate, and/or meaningfully utilize as described above.

Furthermore, the foregoing problems can be easily exacerbated due to the frequency of software updates. Specifically, frequent software revisioning and updating can lead to changes in data tracking and usage that go undetected. Alternatively, software updates can require re-scanning of a software application and the associated potential millions of lines of code.

These and other problems exist with regard to conventional application code scanning tools.

### SUMMARY

This disclosure describes on one or more aspects that provide benefits and solve one or more of the foregoing or other problems in the art with systems, non-transitory computer-readable media, and computer-implemented methods that scan application codes to intelligently detect data processing activity components from the application codes and determine data categories for the detected components. In particular, the disclosed systems can analyze an input application code to detect one or more data processing activity components that represent various software library references, protocol references, and/or function calls within the input application code. In addition, the disclosed system can further create one or more data categorizations from the scanned input application code to categorize (or define) the various data processing activity components. As an example, the disclosed system can utilize the application code scan to categorize one or more data types and/or data processing purposes represented by the various detected data processing activity components.

Furthermore, one or more aspects of the disclosure describe the disclosed systems that scan multiple versions of application codes to intelligently detect modifications of data categories and/or data processing activity components in-between application versions of the application codes. For instance, the disclosed systems can scan multiple versions of an application code to generate software profiles having data processing activity components and/or data categories for the different versions. Moreover, the disclosed systems can compare the outputs between the software profiles to determine changes in data processing activity components and/or data categories between a first and second version of the application code. For instance, the disclosed systems can identify added and/or removed data processing activity components and/or data categories between the versions of application code.

Additionally, one or more aspects of the disclosure also describes the disclosed systems generating dynamic graphical user interfaces that efficiently display the data processing activity components and data categories to enable quick and insightful access to a wide breadth of information from an application code scan. For instance, the disclosed systems can display the data categories detected in the application code to distill a large number of detected components into understandable and navigable categorized functionalities and/or data types present in the application code. Indeed, in one or more implementations, the disclosed systems can display (or visualize) various (e.g., one or more) types of data collected by a particular data processing activity component to present one or more particular function calls (e.g., classes and/or methods) that collect or share the one or more data types. Additionally, the disclosed systems can also provide selectable elements to navigate between data categories present in an application code, data processing activity components within the data categories, and varying scan profiles for application code. Indeed, in some aspects, the disclosed systems also determine changes of data processing activity components and/or data categories detected between scans of different versions of the application code. Moreover, in some aspects, the disclosed systems can utilize detected location data from the data processing activity components to navigate to portions of code of the application code to locate the data processing activity components within a software development application.

### BRIEF DESCRIPTION OF THE DRAWINGS

The detailed description is described with reference to the accompanying drawings in which:

FIG. 1 illustrates a schematic diagram of an example environment in which an application scanning service system operates in accordance with some aspects.

FIG. 2 illustrates an overview of an application scanning service system generating user interfaces that display data processing activity components and data categories from application codes in accordance with some aspects.

FIGS. 3 and 4 illustrate exemplary flow diagrams of an application scanning service system detecting data processing activity component target functionality in an input application code in accordance with some aspects.

FIG. 5 illustrates an exemplary flow diagram of an application scanning service system determining analysis data objects from detected data processing activity components in accordance with some aspects.

FIG. 6 illustrates an exemplary analysis data object generated by an application scanning service system in accordance with some aspects.

FIGS. 7 and 8 illustrate an application scanning service system displaying information from a scan of an input application code in accordance with some aspects.

FIG. 9 illustrates an application scanning service system generating a temporary compiled object as part of the compiling process in accordance with some aspects.

FIGS. 10, 11, and 12 illustrate complied objects generated by an application scanning service system as part of the compiling process in accordance with some aspects.

FIG. 13 illustrates an application scanning service system utilizing a compiling process to generate an Issues set from an analysis data object in accordance with some aspects.

FIG. 14 illustrates an example summarizing a relationship between a Result, a current Issue element, and a Detection Data element that an application scanning service system utilizes as part of a compiling process in accordance with some aspects.

FIG. 15 illustrates a complied object generated by an application scanning service system as part of a compiling process in accordance with some aspects.

FIG. 16A illustrates an application scanning service system determining changes of data processing activity components and/or data categories between application code versions in accordance with some aspects.

FIG. 16B illustrates an application scanning service system displaying determined changes of data processing activity components and/or data categories in accordance with some aspects.

FIGS. 17A-17B illustrate examples of an analysis set that includes analysis objects that an application scanning service system utilizes as part of an exemplary comparison process to determine changes of data processing activity components and/or data categories between application code versions in accordance with some aspects.

FIG. 18 illustrates an application scanning service system creating a Unique set as part of an exemplary comparison process in accordance with some aspects.

FIG. 19 illustrates an application scanning service system modifying a Unique set as part of an exemplary comparison process in accordance with some aspects.

FIG. 20 illustrates an application scanning service system modifying an analysis object as part of an exemplary comparison process in accordance with some aspects.

FIG. 21 illustrates a schematic diagram of an example environment in which an application scanning service system and software development environment operates in accordance with some aspects.

FIG. 22 illustrates an example of an application scanning service system enabling a development application to display and locate target functionalities from scan results in an application code in accordance with some aspects.

FIG. 23 illustrates a flowchart of a series of acts for scanning an application code to determine data categories for the application code in accordance with some aspects.

FIG. 24 illustrates a flowchart of a series of acts for determining data processing activity and/or data category modifications between scanned versions of an application code in accordance with some aspects.

FIG. 25 illustrates a flowchart of a series of acts for displaying scan results of determined data categories in an application code in accordance with some aspects.

FIG. 26 illustrates a block diagram of an example computing device in accordance with some aspects.

### DETAILED DESCRIPTION

One or more aspects of the present disclosure include an application scanning service system that scans an application code to determine data processing activity components for the application code and one or more data categories for the data processing activity components. In particular, the application scanning service system can determine, from detected data processing activity components within an application code, one or more data categories that indicate data types and/or data processing purposes (or functionalities) within the application code. In addition, the application scanning service system can also generate (or display) dynamic graphical user interfaces (GUIs) to indicate the data types processed by an application code and/or types of functionalities implemented in the application code (via the determined data categories). Furthermore, in one or more aspects, the application scanning service system compares detected data processing activity components and data categories scanned in different versions of an application code to display, within the dynamic GUIs, changes or modifications in the data processing activity components and data categories between the application code versions.

In one or more aspects, the application scanning service system scans an application code to generate analysis data objects that represent one or more data processing activity components with corresponding data categories. For instance, the application scanning service system can analyze an application code to identify one or more matching components from a detector specification having mappings between source code identifiers, component names or identifiers, and/or data categorization information. Moreover, in some aspects, the application scanning service utilizes the matched data processing activity components to determine data categorizations that indicate data types processed in an application, purposes for the data type processing (e.g., types of processing, types of functions) implemented in the application, and/or owners and/or developers for the various data processing activity components.

Additionally, the application scanning service system can generate various graphical user interfaces to display the output analysis data objects for the application code scan. In some cases, the application scanning service system generates graphical user interfaces that establish various data categories present in an application code. For example, the application scanning service system can display an indication of the types of data being processed by an application code, such as, but not limited to, location data, computing device data, demographic data, hit-level data, cookie data, and/or device usage data. Furthermore, the application scanning service system can display an indication of data processing purpose types implemented in the application code, such as, but not limited to, application functions, advertisement targeting processes, data aggregation processes, and/or debugging processes.

Moreover, the application scanning service system can also generate graphical user interfaces with selectable options to navigate the various data categories identified from the application code. For instance, the application scanning service system can enable selectable options for the data categories that, in response to a user interaction with the selectable option, the application scanning service system displays one or more data processing activity components from the application code that correspond to the selected data category. Indeed, in one or more aspects, the application scanning service system displays components, such as, but not limited to one or more software development kit (SDK) components, application programming interface (API) components, and/or or function call components present within the application code for the selected data category.

Additionally, in one or more aspects, the application scanning service system determines modifications in detected data processing activity components and/or data categories between different versions of an application code. In particular, the application scanning service system can generate a software profile with a first set of data processing activity components and/or data categories detected in a first version of an application code via a scan (in accordance with some aspects herein). Moreover, upon identifying a second version of the application code, the application scanning service system can scan the second version of the application code to detect a second set of data processing activity components and/or data categories (to generate an additional software profile). Additionally, the application scanning service system can compare the outputs between the software profile and the additional software profile to determine changes in data processing activity components and/or data categories between the first and second version of the application code. For instance, the application scanning service system can identify added and/or removed data processing activity components and/or data categories. In some cases, the application scanning service system also determines a total number of added and/or removed data processing activity components and/or data categories.

In some aspects, the application scanning service system also generates, via an application code scan, analysis data objects that include location data with the data processing activity component and data categories information. For instance, the application scanning service system utilizes location data from the application code to map detected data processing activity components and/or data categories to specific portions (or lines) in the application code. In some cases, the application scanning service system utilizes the location data to display indicators within a development application graphical user interface to locate a data processing activity component and/or data category within the application code.

The disclosed application scanning service system provides several advantages over conventional systems. Unlike many existing scanning tools that generate outputs that simply list each detected component in an application code, the application scanning service system intelligently scans an application code to generate a wide breadth of information for the application code. For example, in contrast to existing scanning tools, the application scanning service system maps SDK components and other data processing activity components to data categories that enable a holistic view of an application code beyond a listing of individual components that exist in the application code.

Indeed, by determining data processing activity components and one or more data categories that represent data types and/or functionalities of the data processing activity components, the application scanning service system can generate graphical user interfaces that result in intelligent, insightful scan results for an application code. For instance, the application scanning service system can scan an application code and automatically generate graphical user interfaces that display easy to comprehend insight into processed data types and purposes for data processing in an application code even when the application code contains a large number of components (e.g., thousands or millions of lines of code representing a substantial number of components). In addition, the application scanning service can generate graphical user interfaces that result in intelligent, insightful scan results for an application code which are practically useable in various applications, such as, software profiles, software audits, and/or to display tracked data in the application code within a software deployment platform.

Additionally, as mentioned above, many conventional code scanning tools are often difficult (and inefficient) to navigate. In contrast, the application scanning service system generates graphical user interfaces with application code scan results that easily and quickly enable access to data categories within the application code and data processing activity components detected for the data categories. In particular, the application scanning service system condenses large lists of data processing activity components from an application code scan within selectable elements for data categories. Upon receiving a single user interaction with a data category, the application scanning service system can display the data processing activity components related to the data category and/or various information for the data processing activity components within a single, viewable user interface. In many cases, the application scanning service system generates such graphical user interfaces to reduce inefficient user navigation between various libraries, a scan result UI, and/or search engines to determine the listed components (and the components' purpose).

Furthermore, the application scanning service system enables various improvements in user interface navigation for application code scans. For instance, the application scanning service system can generate graphical user interfaces that enable quicker (and efficient) navigation to detect data processing activity component (or data category) changes between versions of an application code. To illustrate, in many conventional systems, users are unable to determine differences between detected data categories or data processing activity components between multiple versions of an application code without manually navigating in between multiple scans of the multiple versions of the application code. In contrast, the application scanning service system can determine and display data processing activity component (or data category) changes between versions of an application code to enable efficient insight into the detected scanning differences without navigation between different scan reports of multiple versions of the application code. Moreover, unlike conventional systems, the application scanning service system also generates software profiles that track in which version a data processing activity component (or data category) was changed (e.g., added or removed) to provide efficient insight between more than two application code scans in a single graphical user interface (i.e., a single scan report interface).

Additionally, the application scanning service system can also assign location data to detected data processing activity components and/or data categories to enable quick navigation to a portion of the application code (within a development application graphical user interface). Indeed, the application scanning service system can pinpoint and display the application code portions that correspond to the detected data processing activity components and/or data categories. Additionally, the application scanning service system can also quickly navigate to the portion of the code, within a development tool, to enable modification and/or removal of the detected data processing activity components (e.g., functions that track privacy data, functions that access device hardware).

Indeed, the application scanning service system, via the application code scan, provides a practical application that allows for efficient application code modifications in light of changes in data privacy management and/or data privacy laws. To illustrate, in many cases, application administrators or developers may change (or modify) application code to address frequent updates in data privacy management and/or data privacy law. Oftentimes, in response to such updates, many conventional systems require administrators or developers to identify portions of an application code that relate to the updated data management policies and/or laws through a tedious and time consuming review of the application code. Unlike such conventional systems, the application scanning service system utilizes assigned location data to detected data processing activity components and/or data categories to enable quick navigation to a portion of the application code that relates to the updated data management policies and/or data laws. In addition, the application scanning service system can also enable development tools to efficiently navigate to the portions of the application codes to allow administrators and/or developers to modify the application code to reflect the updated data management policies and/or data laws.

In many cases, the application scanning service system scans application codes to generate graphical user interfaces with practical applications. For instance, the application scanning service system generates graphical user interfaces with detected data processing activity components and/or data categories to enable detection of the components existing within (often large) application codes for data privacy applications and/or software application audits. Indeed, in some cases, the application scanning service system utilizes the detected data processing activity components and/or data categories for compliance determinations (e.g., to detect for certain types of data processing within application codes). For instance, in some instances, a software deployment platform system utilizes outputs and/or user interfaces of the application scanning service system to detect data processing activities within an application code prior to distributing a software application. This enables the developer to understand what data is being tracked/used by a software application prior to deploying the software application. This in turn allows the software deployment system to manage consent of users who will access the software application. In some cases, the application scanning service system enables displaying of the detected data processing activity components and/or data categories within the software deployment platform system user interfaces to enable users to view data processing activities within an application code prior to downloading an application.

Additionally, certain aspects of the application scanning service system improve the accuracy of computing systems that manage digital data trackage/usage in accordance with requirements for various data policies. In particular, the application scanning service system utilizes data categories and data processing purpose types detected in an application code in connection with any number of data policies and data assets to accurately determine relationships between the data policies and software application use of data. In particular, by classifying data categories and data processing purpose types in relation to the data policies, the application scanning service system can automatically detect that specific code lines or SDKs of an application code that violate a particular data policy. In particular, the application scanning service system leads to faster data access times and reduces the computational load spent searching for code or SDKs relevant to one or more data policies.

Overview of Application Scanning Service System

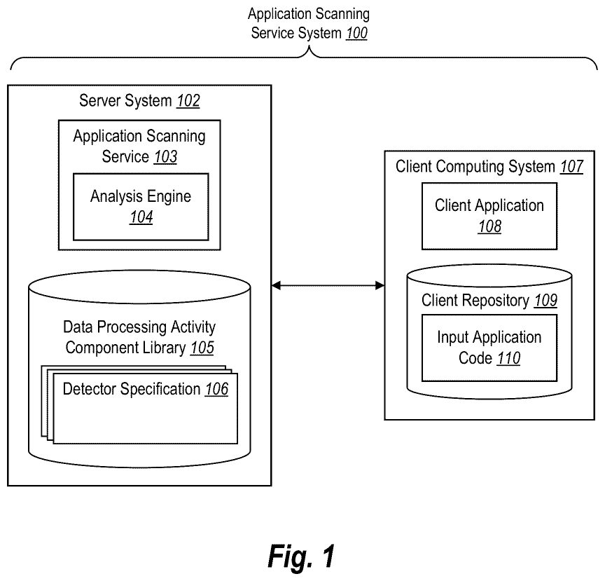

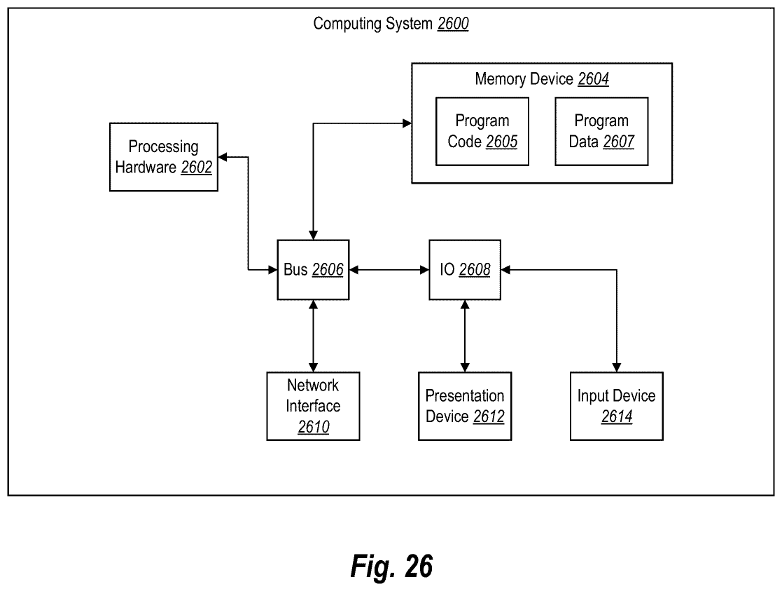

Turning now to the figures, FIG. 1 illustrates a schematic diagram of a system environment in which an application scanning service system 100 can operate in accordance with one or more aspects. Indeed, FIG. 1 depicts an example of an application scanning service system 100 that includes a server system 102 and a client computing system 107. In the example environment depicted in FIG. 1, software components in the server system 102 are communicatively coupled with software components in the client computing system 107. In one or more aspects, the server system 102 can operate on a server device(s). Indeed, the server device(s) can include variety of types of computing devices, including those described with reference to FIG. 26.

As shown in FIG. 1, the server device includes an application scanning service 103. Indeed, the application scanning service system 100 can enable the application scanning service 103 to scans an application code to determine data processing activity components for the application code and one or more data categories for the data processing activity components (as described herein).

As used herein, the term “application code” refers to a set of instructions (or commands) that execute an application (e.g., a software, computer program). In particular, the term “application code” can refer to a set of text (e.g., source code) representing instructions that compile and/or assemble to a machine-readable format that is executable as a digital application. For example, an application code can include software source code, object code, a mobile phone application package (e.g., an Android Package Kit (APK) files, IPA files), and/or markup scripts, such as, but not limited to, C++ code, Java code, Python scripts, Javascript, HTML, and/or binary assembly code. In some cases, an application code can include a collection of multiple software source code, object code, and/or markup scripts to represent function calls, data, variable SDKs, APIs, and/or other libraries involved in an application.

Furthermore, as used herein, the term “data processing activity component” refers to a reference, instruction, or object within an application code that causes the performance of one or more actions associated with data. In some cases, the data processing activity component includes a data processing operation including, but not limited to, a computing process or action corresponding to execution of processing instructions to process, collect, access, store, retrieve, modify, or delete target data. To illustrate, a data processing activity component can include, but is not limited to, a software development kit (SDK) component, mobile SDK, application programming interface (API) component, website cookies, website functions, or function call component within an application code (that enables processing, collecting, accessing, storing, retrieving, modifying, or deleting data).

In addition, as described herein, the application scanning service system 100 can enable the application scanning service 103 to determine, from detected data processing activity components within an application code, one or more data categories that indicate data types and/or data processing purposes (or functionalities) within the application code. Additionally, the application scanning service system 100 can enable the application scanning service 103 to display graphical user interfaces (GUIs) to indicate the data types processed by an application code and/or types of functionalities implemented in the application code (via the determined data categories) and/or changes or modifications in the data processing activity components and data categories between the application code versions (in accordance with some aspects). Although one or more illustrations below describe the application scanning service system 100 performing some aspects, the application scanning service system 100 can enable the application scanning service 103 to perform the some aspects.

As used herein, the term “data category” refers to a label or representation that groups one or more data processing activity components with shared descriptor. In particular, the term “data category” can refer to a label or representation that groups one or more data processing activity components to indicate a data type related (or corresponding) to the data processing activity component (e.g., data processing activity components with a data category of location data, cookie data, demographic data). In one or more aspects, a data category can include a label or representation that groups one or more data processing activity components to indicate a purpose type corresponding to the data processing activity components (e.g., data aggregation, digital advertisement targeting, debugging, authorization).

Furthermore, as used herein, a “data type” refers to a particular kind of data object defined by values represented by the data object and/or operations performed on the data object. For example, a data type can include a representation of values and/or information indicated by a particular data object. For instance, a data type includes, but not is not limited to, location data, cookie data, camera data, demographic data, computing device data, device usage data, hit-level data, biometrics data, and/or personal identifiable information (PII) data.

In addition, as used herein, a “data processing purpose type” refers to a representation of particular kind of utilization for a data object. For example, a data processing purpose type can indicate how a data object is utilized by a data processing activity component. To illustrate, a data processing purpose type can represent a functionality achieved by the data processing activity component. For instance, a data processing purpose type can include utilizing a data object for an application function, such as but not limited to, generating displays, calculating values, handling user interactions, accessing a device camera, accessing images, monitoring device sensor data). In some cases, a data processing purpose type can include digital advertisement targeting (e.g., tracking interactions with advertisements, collecting user data to display targeting digital advertisements). In one or more aspects, the data processing purpose type can include data aggregation, such as, but not limited to, collecting device usage data to aggregate battery health data, collecting location data to aggregate traffic data). Moreover, in some instances, the data processing purpose type can include debugging (e.g., generating process logs, generating crash logs).

Additionally, the application scanning service system 100 includes automation and intelligence features for scanning input applications to detect data processing activities performed by or facilitated by the input applications. For instance, input applications, such as a mobile application, a web application, a website, or connected TV application, often include data processing activity components, such as, but not limited to software development kit (“SDK”) components, APIs, and/or other functions. Such data processing activity components (e.g., SDK components implemented for the input application) can be configured to collect, store, or otherwise use data associated with an end user interacting with (and/or a user device operating) the input application (e.g., user behavior, preferences, device location, device usage data, etc.).

Furthermore, the application scanning service system 100 can scan and categorize such data processing activity components (e.g., the SDK functionality) in the input application, including functionality that is unknown to a developer of the input application. In one or more aspects, the application scanning service system 100 can scan an input application (to determine data processing activity components and/or data categories as described herein) to facilitate any appropriate modifications to the input application (e.g., updates to reduce or restrict data collection activities). Moreover, the application scanning service system 100 can scan an input application (to determine data processing activity components and/or data categories as described herein) to disclose and/or detect (known and/or unknown) operations performed by the input application (e.g., to the operator of a third-party application deployment platform via which the input application will be provided to end users).

In one or more aspects, as shown in FIG. 1, the application scanning service system 100 can be implemented (as described herein), in whole or in part, within the server system 102 (via the application scanning service 103). In some aspects, the application scanning service system 100 can be implemented (as described herein), in whole or in part, within the client computing system 107 (e.g., via a client application 108).

The server system 102 also includes one or more repositories that can store one or more data processing activity component libraries (e.g., SDK libraries, API references). For instance, as shown in FIG. 1, the data processing activity component library 105 can include one or more detector specifications 106 for various data processing activity components. Indeed, in some aspects, the data processing activity component library 105 includes detector specifications 106 for a set of data processing activity components (e.g., identifiers for the components and descriptive data for the components as described herein). As an example, the data processing activity component library 105 can include one or more SDK libraries with one or more detector specifications for the SDKs. Additionally, in one or more cases, the data processing activity component library 105 can include one or more API references with one or more detector specifications for the APIs and/or one or more scripting language (e.g., Python, Javascript) functions with one or more detector specifications for the one or more scripting language functions.

Furthermore, as used herein, the term “detector specification” refers to mappings between one or more data processing activity component identifiers and descriptive data for the data processing activity component identifiers. For example, a detector specification can include identifiers that indicate a particular data processing activity component, such as, but not limited to, a namespace, a hash, and/or a text string corresponding to the data processing activity component. In addition, the detector specification can include descriptive data for the data processing activity components to represent various aspects of the data processing activity components. For instance, the detector specification can include descriptive data such as, but not limited to, a data category type, one or more identifiers for the component, source information, a description of the component to describe a purpose of the data processing, device access permissions, variables and data types utilized in the component, and/or a version of the component. Indeed, the application scanning service system utilizes a detector specification to map data processing activity component identifiers detected within an application code to extract and/or assign descriptive data (e.g., data categories, purpose of data processing) to specific data processing activity components in the application code. In one or more aspects, a detector specification includes a decision tree, a data object entry (e.g., a JSON entry, a CSV entry), a database entry, a relational graph that creates connections between data processing activity components and descriptive data.

### Detector Specification Description and Example

In one or more aspects, the application scanning service system 100, via the application scanning service 103, scans an input application code 110 for the input application search and utilizes defined features from a detector specification 106 to determine one or more data processing activity components and/or data categories. In particular, as mentioned above, the detector specification 106 can include mappings between defined features of a data processing activity component and an identifier for the data processing activity component. The application scanning service system 100 can scan the input application code 110 to identify one or more data processing activity component identifiers and search the detector specification 106 to generate (or determine) defined features for the one or more data processing activity components.

In some aspects, the detector specification 106 can include data categorizations mapped to input application code features detected in such a scan. In particular, the detector specification 106 can include data categories (e.g., data types, data processing purpose types, component owner and/or developer identifiers) within the detector specification 106. In one or more aspects, the application scanning service system 100 identifies the data categories from objects (or data) mapped to a particular data processing activity component identifier. In some cases, the detector specification 106 can include data categories within the detector specification 106 with rules and/or protocols on applying the data categories to a specific data processing activity component. For example, the detector specification 106 can include rules to apply a data category to a specific data processing activity component by analyzing the description associated with the data processing activity within the detector specification 106 (e.g., identifying a particular data type or function type).

For instance, a detector specification 106 can include data processing activity component identifying search criteria (e.g., an identifier), such as one or more network addresses (e.g., a Uniform Resource Locator (“URL”)) and/or a namespace that could be included in the code of an input application, one or more methods names that could be included in or otherwise invoked by in the code of an input application, whether a method is called by first-party code (e.g., functions defined within the input application) or third-party code (e.g., functions defined by an external library used by the input application). The detector specification 106 can also include, mapped to a particular feature in the search criteria (e.g., a data processing activity component identifier), metadata indicating descriptive data for the data processing activity component such as, but not limited to, data categories for the particular feature in a scan result generated by scanning the input application.

As an example, the application scanning service system 100 can utilize a detector specification represented through a structure file that includes data processing activity component identifiers and descriptive data for the data processing activity component identifiers. For instance, Table 1 (below) illustrates an example of a detector specification as a structure file. In this example, the detector specification includes a structured document (e.g., a JSON formatted file) an “SDK” object (e.g., a data processing activity component object with various metadata, including data categories). In some aspects, as shown in Table 1, the application scanning service system 100 can utilize detector objects (e.g., detector specification entries) from a detector specification to identify and extract information for a data processing activity component. Furthermore, the Table 1 also includes a description of the JSON SDK object and the detector object within the detector specification.

In Table 1, the SDK object in the detector specification defines a list of one or more SDK namespaces for an SDK. For example, the “namespace” can include a top-level package name of an SDK. Furthermore, as shown in Table 1, classes in the SDK can be included in one or more namespaces below the top-level namespace. In response to the application scanning service 103 detecting a declaration of this top-level namespace for the SDK in an input application code, the application scanning service 103 can determine that the SDK is in the input application code.

TABLE 1
Detector Specification Example

| Example | Description |
|---|---|
| ″sdk″: { | In this example, the “name” is an identifier of the SDK (e.g., |
| ″name″: ″company1.com Library″, | “company1.com Library”) that the application scanning service |
| ″namespace″: ″com. | system 100 can include in a scan report displayed on an end user |
| company1.vs.mobile.library″, | device. Furthermore, the “namespace” section can define, for |
| ″description″: ″ company1.com, an e- | each namespace, the namespace as it would be included in the |
| commerce company, solves some of the | code of an input application (e.g., |
| biggest challenges in search and | ″com.company1.vs.mobile.library”). In this example detector |
| advertising. We focus on helping people | specification entry, the “category” section identifies a data |
| find the things they want.″, | category for the SDK to be included in a scan report (e.g., |
| ″category″: ″Cookie Category″ | ″Cookie Category″). |
| } | |
| ″detectors″: [ | A detector object, as shown in the “detectors” section, can |
| { | include an internal identifier utilized by the application scanning |
| ″uuid″: ″2e3fe892-1cc5-4916- | service system 100 to identify a particular detector specification |
| 896e-138a73ab8bc6″, | in a scan result (e.g., ″uuid″: ″2e3fe892-1cc5-4916-896e- |
| ″category″: ″LOCATION″, | 138a73ab8bc6″ can correspond to a detector specification). |
| ″purpose″: ″ANALYTICS″, | Additionally, as shown in the example, the detector object can |
| ″targets″: [ | also include one or more of: |
| { | a “category” (e.g., “LOCATION”) identifying the data |
| ″className″: | category for data collected by the target data processing |
| ″com.company1.vs.mobil | activity component functionality (associated with the text |
| e.library.impl.jni.Locatio | of the data processing activity component) and/or |
| nSuggestion″, | a “purpose” (e.g., “ANALYTICS”) identifying a purpose |
| ″methodName″: | for which the target data processing activity component |
| ″getLocation″, | functionality collects the data. |
| ″dataType″: | A detector specification entry in this section can also include one |
| ″APPROX_LOCATION | or more target functionalities, such as method names and their |
| ″ | class as included in the code of an input application (e.g., a target |
| }, | functionality having a class name |
| { | “com.company1.vs.mobile.library.impl.jni.ObjectInfo” and |
| ″className″: | method name “getLocation”), as well as a specific data type in |
| ″com.company1.vs.mobil | the data category (e.g., ″APPROX_LOCATION″). |
| e.library.impl.jni.ObjectI | |
| nfo″, | |
| ″methodName″: | |
| ″getLocation″, | |
| ″dataType″: | |
| ″APPROX_LOCATION | |
| ″ | |
| } | |
| ] | |

In some cases, in reference to Table 1, the application scanning service system 100 can utilize an index from a third-party SDK manager (and/or software deployment platform) to classify or identify various SDKs (or other data processing activity components). For instance, the application scanning service system 100 can integrate, as part of the detector specification, a third-party index (from a third-party software deployment platform) that includes one or more data processing activity components (e.g., SDKs) recognized by the third-party software deployment platform. Indeed, the application scanning service system 100 can utilize the data processing activity components from the third-party index as part of the detector specification to identify the data processing activity components in an application scan (in accordance with one or more implementations herein).

In reference to the example in Table 1, the application scanning service system 100 can generate internal identifiers for data processing activity components from identifiers for the data processing activity components. For example, the application scanning service system 100 can generate and/or utilize a universally unique identifier (“UUID”) by transforming one or more identifiers, such as namespaces and/or text of methods into unique identifier values. As an example, the application scanning service system 100 can generate a hash from information in one or more detector specification entries (e.g., detector identifier or from a combination of the detector group and detector identifiers) related to a particular data processing activity component. For example, the application scanning service system 100 can generate a UUID (e.g., an internal identifier) by generating a hash from a namespace within the detector specification entry for a data processing activity component.

Furthermore, Table 2 includes an additional example of a detector specification. In Table 2, the detector specification includes a structured document (e.g., a JSON formatted file) having an “SDK” object and a detector object (e.g., a detector specification entry) from a detector specification. For instance, as shown in Table 2, the SDK object section defines a list of one or more SDK namespaces for an SDK. In addition, as shown in Table 2, the SDK object section also includes classes in the SDK that are in one or more namespaces below the top-level namespace of the SDK. As an example, in response to the application scanning service system 100 detecting a declaration of a top-level (or nested) name space in an input application, the application scanning service system 100 can determine that the SDK (corresponding to the SDK object) is in the input application.

TABLE 2
Detector Specification Example

| Example | Description |
|---|---|
| ″sdk″: { | In this example, the “name” is an identifier of the SDK (e.g., |
| ″name″: ″Adjust SDK″, | “Adjust SDK”) that the application scanning service system |
| ″namespaces″: [ | 100 can be included in a scan report displayed to an end user |
| { | device. Furthermore, the “namespaces” section defines, for |
| ″id″: ″adjustAdvertisingNetwork″, | each namespace: |
| ″name″: ″Adjust Ad Network SDK | the namespace as it would be included in code of an |
| for Phone OS″, | input application (e.g., ″com.adjust.sdk″), |
| ″description″: ″Industry leader in | an internal identifier used by the application |
| mobile measurement and fraud prevention.″, | scanning service system 100 to identify the |
| ″namespace″: ″com.adjust.sdk″, | namespace within a scan result (e.g., |
| ″category″: ″ Cookie Category ″, | ″adjustAdvertisingNetwork″), |
| } | an external identifier (e.g., ″Adjust Ad Network |
| ] | SDK for Phone OS″) and description (e.g., |
| } | “″Industry leader in . . . ”) that the application |
| | scanning service system 100 can include in a scan |
| | report displayed to an end user device, and/or |
| | a data category for the SDK that the application |
| | scanning service system 100 can include in the scan |
| | report (e.g., ″Cookie Category″). |
| ″detectorGroups″: [ | In this example, each detector object entry (e.g., |
| { | “detectorGroups”) includes: |
| ″id″: ″adjustAdSdk″, | an internal identifier utilized by the application |
| ″name″: ″Adjust SDK″, | scanning service system 100 to identify the detector |
| ″detectors″: [ | entry (or group) within a scan result (e.g., |
| { | ″adjustAdSdk″) and/or |
| ″id″: ″adjustDeviceId″, | an external identifier that the application scanning |
| ″name″: ″Device identifiers″, | service system 100 can include in a scan report |
| ″description″: ″This detection has found a | displayed to an end user (e.g., ″Adjust SDK″). |
| user's device info, mobile device Wi-Fi | As also shown in this example, each detector entry object |
| MAC (translated and untranslated) address | can include: |
| history, International Mobile Equipment | an additional internal identifier utilized by the |
| Identity (IMEI) and other device identifier | application scanning service system 100 to identify |
| information method calls in this app.″, | the detector entry (or group) within a scan result |
| ″developerAction″: ″Check off the Device | (e.g., “adjustDeviceId”), |
| identifiers identifications below once you | an additional external identifier (e.g., “name: Device |
| have confirmed the method calls behave as | identifiers”), description (e.g., “This detection has |
| you designed. These will also be displayed | found . . . ), and developer action (e.g., “Check off the |
| as reviewed (checked off) on the next | . . . ) that the application scanning service system 100 |
| analysis.″, | can include in the scan report, |
| ″type″: ″Analytics″, | data collection information (e.g., as a data category) |
| ″targets″: [ | to indicate the data type collected by target |
| { | functionalities (e.g., “type”: |
| ″className″: | ″APPROX_LOCATION″) in the detector entry |
| ″com.adjust.sdk.plugin.MacAddressUtil″, | and/or the purpose type of this data collection (e.g., |
| ″methodName″: ″getMacAddress″ | “type: Analytics”), and/or |
| }, | one or more target functionalities, such as method |
| { | names and their class as included in the code of an |
| ″className″: | input application (e.g., a target functionality having |
| ″com.adjust.sdk.plugin.MacAddressUtil″, | class name |
| ″methodName″: ″getRawMacAddress″ | “com.adjust.sdk.plugin.MacAddressUtil” and |
| }, | method name “getMacAddress”). |
| { | |
| ″className″: | |
| ″com.adjust.sdk.IActivityHandler″, | |
| ″methodName″: ″getDeviceInfo″ | |
| }, | |
| { | |
| ″className″: | |
| ″com.adjust.sdk.MacAddressUtil,″, | |
| ″methodName″: ″getMacAddress″ | |
| } | |
| ] | |
| }, | |
| { | |

In reference to Table 2, the application scanning service system 100 can utilize a detector specification to generate (or create) a list of detector specification entries (e.g., “detectorGroups”). Indeed, the application scanning service system 100 can generate a list of detector specification entries for various detector specifications. Additionally, the application scanning service system 100 can utilize one or more detector specification entries to separately detect a module of a data processing activity component (e.g., an SDK component, an API component) from multiple (nested) components that might be included in the data processing activity component. In one or more aspects, the application scanning service system 100 can also utilize the detection specification entry (e.g., a detector group or object) to enable forward compatibility when the detector specification is updated (or modified) to identify additional behaviors, data processing activity components, and/or data categories to detect in an input application. Indeed, the application scanning service system 100 can uniquely identify each detector entry by a detector group identifier and/or a detector identifier (as shown in Tables 1 and 2).

In the examples depicted in Tables 1 and 2, the application scanning service system 100 can declare multiple top-level “namespaces” (within a detector specification entry). In one or more aspects, the application scanning service system 100 can utilize multiple top-level “namespaces” in the detector specification to enable (or account for) modular data processing activity component grouping (e.g., an SDK). As an example, the application scanning service system 100 can utilize, from the data processing activity component library 105, a single detector specification for multiple top-level “namespaces” of the grouped data processing activity component (e.g., SDK) and/or can utilize different detector specifications for different top-level “namespaces” of that grouped data processing activity component (e.g., SDK) (based on an effectiveness in detecting and classifying data processing activity features within an input application).

The examples in Tables 1 and 2 are provided for illustrative purposes. The application scanning service system 100 can utilize, combine, and/or modify the features of these examples (and/or one or more other detector specifications) to implement an application service described herein.

As mentioned above, in one or more aspects, the application scanning service system 100 updates a detector specification. In particular, in one or more cases, the application scanning service system 100 detects and/or receives changes to one or more data processing activity components and/or data processing activity component groups. In some instances, the application scanning service system 100 pulls or retrieves changes to one or more data processing activity components and/or data processing activity component groups via a source, such as, but not limited to, a source code repository and/or a software development version controlling platform. Moreover, the application scanning service system 100 can utilize the detected changes in the one or more data processing activity components and/or data processing activity component groups to update data categories, identifiers, and/or other information for the one or more data processing activity components and/or data processing activity component groups within the detector specification.

In some applications, the application scanning service system 100 can create and/or implement one or more hierarchical categorization schemes via the detector specification for data processing activity components. For instance, the application scanning service system 100 can associate a first categorization level (e.g., a high-level data type such as “LOCATION” or a high-level purpose such as “ANALYTICS) to a first hierarchical level in a detector specification entry (or grouping of detector specification entries). Moreover, the application scanning service system 100 can associate a second, more specific, categorization level (e.g., a more specific sub-type of “LOCATION” such as “APPROX LOCATION” or “ADDRESS”) to a second hierarchical level in a detector specification entry (or a grouping of detector specification entries) for a specific data processing activity component and/or target functionality within the detector specification.

Although some aspects herein describe utilizing a particular data object entries (e.g., JSON entries), the application scanning service system 100 can utilize various types of detector specifications. For instance, the application scanning service system 100 can utilize a matrix-based detector specification that maps between one or more data processing activity component identifiers and descriptive data (e.g., data types, purpose of data processing) for the data processing activity component identifiers. As another example, the application scanning service system 100 can utilize a lookup table-based detector specification that enables queries of identified data processing activity components and/or data processing activity components identifiers to retrieve descriptive data (e.g., data types, purpose of data processing) for the data processing activity component identifiers.

Furthermore, FIG. 1 includes a client computing system 107. In one or more aspects, the client computing system 107 includes a system operated (or implemented) on a computing device (or a network of computing devices). Indeed, the computing device of the client computing system 107 can include a variety of types and number of computing devices, including those described with reference to FIG. 26. In some cases, the client computing system 107 includes a developer computing system, a source code management system, and/or a software deployment platform. In addition, the client computing system 107, via the client application 108, can deploy, modify, display, and/or execute one or more application codes and/or one or more applications corresponding to the application codes.

In some cases, the client computing system 107 includes a system operated on a user device operated by a user of an application. In one or more embodiments, the client computing system 107, via the client application 108, can execute an application from the input application code 110 in the client repository 109. Furthermore, within the application scanning service system 100 environment, the user device-based client application 108 can communicate with the server system 102 to scan the input application code 110 in accordance with some aspects herein.

As shown in FIG. 1, the client computing system 107 includes a client repository 109. In one or more instances, as shown in FIG. 1, the client computing system 107 stores one or more application codes as input application code 110 within the client repository 109. Indeed, the client repository 109 can include one or more application codes for one or more applications and/or data processing activity components (e.g., an SDK, API, code library).

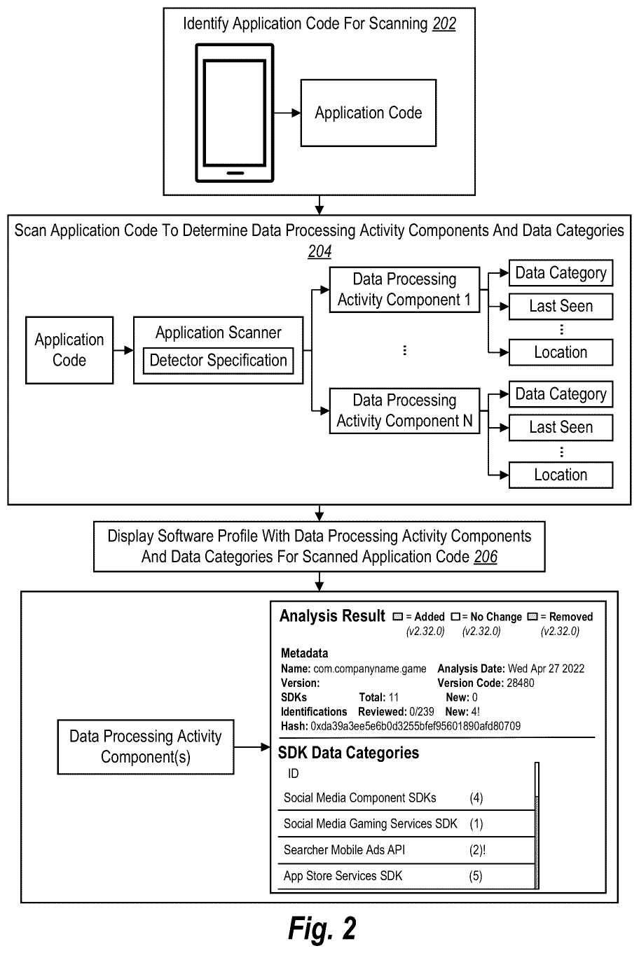

Indeed, in the example illustrated in FIG. 1, the server system 102, via the application scanning service system 100, can execute an application scanning service 103 that can access a data processing activity component library 105. The server system 102 can access input application code 110, which can be uploaded or otherwise provided to the application scanning service system 100 via the client application 108 executed on the client computing system 107 (as described above). Moreover, the application scanning service system 100 can cause the application scanning service 103, via an analysis engine 104, to scan the input application code 110 and determine data categories for data that is collected by the input application code 110 (when executed) as described herein (e.g., in reference to FIGS. 2-7).

To illustrate an example of the application scanning service system 100 performing a scan of an input application in the environment illustrated in FIG. 1, the application scanning service system 100 can cause the application scanning service 103 to parse the input application code 110 and compare various features (e.g., data processing activity components) of the input application code 110 to the search criteria and metadata in the detector specification 106. For instance, the application scanning service 103 can determine a particular detector specification entry and/or a detector specification entry group to which the data processing activity component belongs from one or more detector specifications (in the data processing activity component library 105). Moreover, the application scanning service 103 can identify a data category (e.g., a type of data collection or purpose type) associated with the detector specification entry and/or detector specification entry group in the detector specification. Utilizing the identified data category, the application scanning service 103 can categorize the input application as collecting the type of data or the purpose type for the data in the application code when the detected data processing activity component (e.g., a function call, a method call, a library reference) is linked to the detector specification entry group via the detector specification.

In various implementations, the application scanning service system 100 can parse code from assembly language code obtained by disassembling the input application code 110 and/or source code obtained by decompiling the input application code 110. For instance, the application scanning service system 100 can cause the application scanning service 103 to determine whether a particular data processing activity component identified in a detector specification exists within the input application code 110 via identifiers for the assembly language code within a detector specification, whether the data processing activity component (e.g., a method, function call) is called by any other data processing activity component within the input application code 110, and/or whether the calling data processing activity component is first-party code or third-party code within the input application code 110. Furthermore, when the application scanning service 103 detects the presence of a particular data processing activity component within the input application (or the input application code 110), the application scanning service 103 can categorize the detection in accordance with some aspects herein.

Moreover, although FIG. 1 illustrates the environment with a single server system 102 and a single client computing device 107, in one or more aspects, the application scanning service system 100 can interact with additional computing systems (or various numbers of computing devices within the computing systems). For example, the application scanning service system 100 can interact with a variety of different numbers of computing systems corresponding to one or more application users and/or administrators (or developers) of applications. Additionally, although FIG. 1 illustrates the application scanning service system 100 interacting with a single client repository 109 and a single data processing activity component library 105, the application scanning service system 100 can interact with a variety of different numbers of data processing activity component libraries, detector specification repositories, and/or client application code repositories.

Moreover, although not shown in FIG. 1, the application scanning service system 100 can utilize network to enable communication between the server system 102 and the client computing system 107. In some instances, the network can include a suitable network and may communicate using any communication platform and technology suitable for transporting data and/or communication signals, examples of which are described with reference to FIG. 26. Moreover, the various components of the server system 102 and the client computing system 107 can communicate and/or interact via other methods (e.g., the application scanning service 103 and the client repository 109 can communicate directly).

As mentioned above, the application scanning service system 100 can scan application codes to generate user interfaces that display data processing activity components from the application codes and/or data categories for the detected components. For example, FIG. 2 illustrates an overview of the application scanning service system 100 generating user interfaces that display data processing activity components from the application codes and data categories for the detected components. More specifically, FIG. 2 illustrates the application scanning service system 100 identifying application code for scanning, scanning an application code to determine data processing activity components and data categories, and display a software profile with data processing activity components and data categories for the scanned application code.

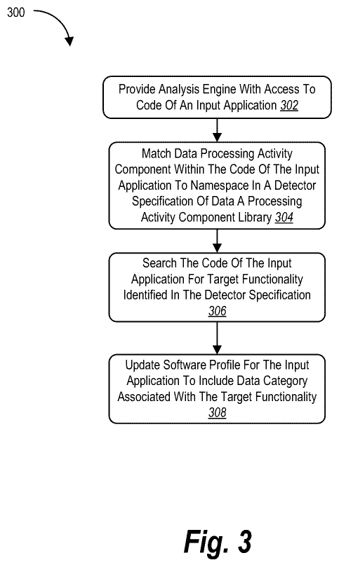

As shown in act 202 of FIG. 2, the application scanning service system 100 identifies application code for scanning. Indeed, in one or more aspects, the application scanning service system 100 receives an input application code from a code repository and/or computing system (as described above). For instance, the application scanning service system 100 can receive an input application code that includes set of instructions (or commands) that execute an application (e.g., a software, computer program). Indeed, the application scanning service system 100 can receive or detect an input application code as described herein (e.g., in reference to FIGS. 1 and 3).

Furthermore, as shown in act 204 of FIG. 2, the application scanning service system 100 scans the application code to determine data processing activity components and data categories. As shown in the act 204 of FIG. 2, the application scanning service system 100 analyzes an application code to identify one or more matching data processing activity component identifiers between parsed code from the application code and a detector to determine (or output) one or more data processing activity components (data processing activity components 1-N). For instance, as shown in the act 204, the application scanning service system 100 determines, from a detector specification, data processing activity components 1-N with descriptive data for the data processing activity components (e.g., data categories, a last seen indicator, a location indicator). Indeed, the application scanning service system 100 can scan an application code and determine data processing activity components and data categories for the application code as described herein (e.g., in reference to FIGS. 3-20).

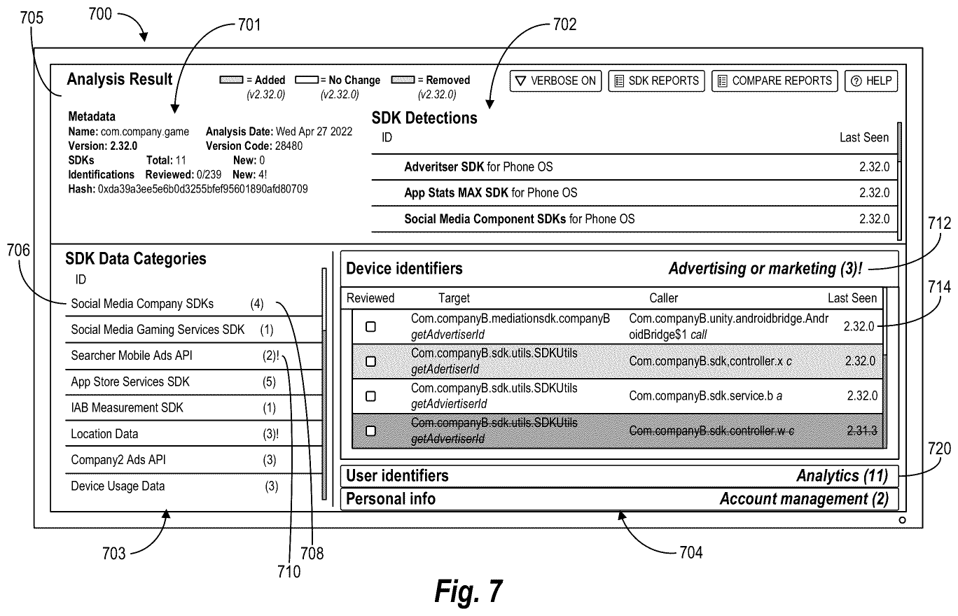

As shown in act 206 of FIG. 2, the application scanning service system 100 displays a software profile with data processing activity components and data categories for the scanned application code. For example, as shown in the act 206 of FIG. 2, the application scanning service system 100 generates graphical user interfaces that establish various data categories present in an application code. In addition, the application scanning service system 100 can display particular data processing activity components present in the application code. Moreover, the application scanning service system 100 can also generate graphical user interfaces with selectable options to navigate the various data categories identified from the application code, that display changes in detected data processing activity components and/or data categories between different versions of the application code, and/or indicators within a development application graphical user interface to locate a data processing activity component and/or data category within the application code. Indeed, the application scanning service system 100 displaying various graphical user interfaces to display the output analysis data objects for the application code scan is described in greater detail below (e.g., in reference to FIGS. 7, 16, and 22).

### Examples of Processes for Detecting SDK Targets

As mentioned above, in one or more aspects, the application scanning service system 100 can scan an input application code to detect (or identify) one or more data processing activity components. FIG. 3 depicts an example of a process 300 for detecting data processing activity component (e.g., SDK, API) target functionality in input application code 110. In some implementations, one or more computing devices, such as a server system 102, implement operations depicted in FIG. 3 by executing suitable program code (e.g., via the analysis engine 104 or other suitable component of the application scanning service 103, etc.). For illustrative purposes, the process 300 is described with reference to certain examples depicted in the figures. Other implementations, however, are possible.

As shown in FIG. 3 in block 302 of the process 300, the application scanning service system 100 can provide the analysis engine 104 (from FIG. 1) with access to code of an input application. In some implementations, the application scanning service system 100, causes the application scanning service 103 to receive, via a communication session established with a client application 108, the input application (or the input application code 110). For instance, the application scanning service system 100 can receive, from a developer or other user of the client computing system 107, an upload of an input application and/or an input application code 110 (e.g., APK, assembly code, scripts, website files) for the application scanning service 103. In some cases, the application scanning service system 100 can cause the application scanning service 103 to utilize a suitable tool, such as the analysis engine 104 or other suitable program included in or accessible to the application scanning service 103, to obtain code of the input application that can be searched for data processing activity components (e.g., SDK components, API components, classes, methods). In some implementations, the analysis engine 104 can access code of the input application code 110 that has been disassembled or decompiled by the application scanning service system 100 and/or an external system and provided to the server system 102.

In some implementations, the application scanning service system 100 utilizes a disassembler tool that translates binary code of the input application into assembly language to obtain code of the input application. For example, the application scanning service system 100 can include (or can access) assembly mapping data that identifies, for each input application element of interest (e.g., SDK namespace, class/method pairs, etc.), a corresponding set of assembly language that implements the class/method pair. For instance, the application scanning service system 100 can utilize the mapping data to identify sets of assembly language for implementing class/method pairs defined in detector specifications.

In some aspects, the application scanning service system 100 utilizes a decompiler that decompiles an input application into application code (e.g., source code) to obtain code of the input application. For example, the application scanning service system 100 can identify (or receive) a compiled application code for an application (e.g., assembly code or machine-readable code). Furthermore, the application scanning service system 100 can utilize a decompiler to decompile (e.g., translate and/or reconstruct) an application code (e.g., in a source code language or combination of source code language used for the application, such as, but not limited to a particular SDK language, a particular API language, Java, C++, python).

In some instances, the application scanning service system 100 receives an application code (e.g., raw source code) from one or more computing devices for an application. For example, the application scanning service system 100 can receive the application code from a developer computer system to scan the application code. In some cases, the application scanning service system 100 can receive the application code from an application deployment platform system (e.g., an app store system) that scans (or requests scans for) uploaded application code for an application deployed (or deploying) on the application deployment platform system.

Furthermore, as shown in block 304 of the process 300, the application scanning service system 100 matches a data processing activity component (or component identifier, such as a namespace) within the code of the input application (e.g., an SDK component or SDK component namespace) to a namespace (e.g., an SDK namespace) in a detector specification of the data processing activity component library 105. For instance, the application scanning service system 100 can cause the analysis engine 104 to reference one or more detector specifications in the data processing activity component library 105 to identify a data processing activity component namespace set. Indeed, the application scanning service system 100 can identify a data processing activity component namespace set that one or more data processing activity component namespaces from one or more detector specifications. In some cases, the application scanning service system 100 can utilize SDK namespaces to identify SDK components by matching with SDK namespaces from one or more detector specifications in an SDK library.

For example, the application scanning service system 100 can cause the analysis engine 104 to search the code of the input application for the data processing activity component namespace. In implementations where the code of the input application is assembly language, the application scanning service system 100 can search the assembly language for an assembly language set corresponding to the data processing activity component namespace in the assembly mapping data (e.g., from a disassembler tool). In implementations where the code of the input application is decompiled source code, the analysis engine 104 searches the source code for any source code portions having a data processing activity component namespace (e.g., an SDK component) matching at least part of the data processing activity component namespace set. In some cases, the application scanning service system 100 can receive encrypted application code and decrypt the encrypted application code prior to scanning the application code in accordance with some aspects herein.

In one or more aspects, the application scanning service system 100 generates a call graph to search the code of an input application. In particular, the application scanning service system 100 determines a recognizable source code from an application code (e.g., an assembly language code, compiled code, raw source code). Moreover, in one or more instances, the application scanning service system 100 generates a call graph from the recognizable source code. For instance, the application scanning service system 100 can generate a call graph that includes a structure of the application code with tiered nodes that indicate and/or represent one or more data processing activity components within the application code.

Indeed, the call graph can include a control-flow graph that represents relationships of routines, subroutines, and/or processes within an application code (via data processing activity components in the application code). For example, the application scanning service system 100 can generate a call graph with nodes for various data processing activity components (e.g., method call or name nodes, function call or name nodes, procedure nodes, namespace nodes, class name nodes) present within the application code (and sub-data processing activity components nested or called by the data processing activity components within the application code). In addition, the application scanning service system 100 can generate the call graph by generating one or more edges between the various data processing activity components present within the application code to represent relationships (or calling relationship) between nodes (e.g., data processing activity component nodes) and sub-nodes called by the nodes (e.g., data processing activity component sub-nodes called by the data processing activity component nodes).

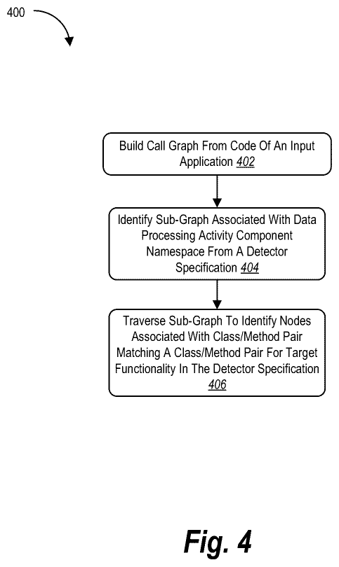

Additionally, as shown in block 306 of the process 300 in FIG. 3, the application scanning service system 100 can search the code of the input application (or call graph generated for the input application code) to identify one or more target functionalities (e.g., target data processing activity components) in the detector specification. For instance, the application scanning service system 100 can identify one or more target functionalities to search for in an application code (or call graph). Furthermore, the application scanning service system 100 can identify the target functionality from the detector specifications that include the matched data processing activity namespaces from block 304. In some cases, the application scanning service system 100 can reference the detector specifications and build a target functionality set that includes one or more class/method pairs. Indeed, the application scanning service system 100 can search the code portions identified in block 306 for matching code from the application code or code that is implementing at least part of the target functionality set. An example of the application scanning service system 100 searching the code of the input application for target functionality is described herein with respect to FIG. 4.

In some cases, the application scanning service system 100 can search the detector specification to identify data processing activity components in the detector specification entries. For example, the application scanning service system 100 can identify data processing activity components in the detector specification entries that match and/or map to one or more data processing activity components (or data processing activity component identifiers) in the scanned application code. The application scanning service system 100 can utilize the matched and/or mapped detector specification entries within a target functionality set to represent the one or more data processing activity components of the application code.

Furthermore, as shown in block 308 of the process 300 in FIG. 3, the application scanning service system 100 updates a software profile for the input application code (or input application) to include a data category associated with the target functionality (e.g., one or more data processing activity components). For instance, the application scanning service system 100 can add one or more scan results to the software profile. Indeed, the application scanning service system 100 can generate multiple scan results (for the software profile) to identify one or more features via data processing activity components (e.g., SDK components, URL components, and/or other target functionality components) identified in a version of the input application.

In one or more cases, the application scanning service system 100 can also identify, from a detector specification and for a respective data processing activity component (e.g., as a feature within the application code), an associated data category, such as the type of data collected and/or the purpose of the data collection in the data processing activity component. For example, the application scanning service system 100 can identify an associated data category and group one or more data processing activity components as part of the data category. Moreover, the application scanning service system 100 can include, within a software profile, the one or more identified data categories that correspond to the application code and/or one or more mappings between data categories and data processing activity components within the application code.

In one or more aspects, the application scanning service system 100 utilizes one or more call graphs created from application code to search the application code for specific, target data processing activity components (e.g., target functionalities) from a detector specification. For instance, FIG. 4 illustrates an example of the application scanning service system 100 detecting target data processing activity components (e.g., target functionalities) in an input application code 110. In some implementations, one or more computing devices, such as a server system 102, implement operations depicted in FIG. 4 by executing suitable program code (e.g., via the analysis engine 104 or other suitable component of the application scanning service 103, etc.). For illustrative purposes, the process 400 is described with reference to certain examples depicted in the figures. Other implementations, however, are possible.

As shown in FIG. 4 at block 402 in the process 400, the application scanning service system 100 builds a call graph from code of an input application. For instance, the application scanning service system 100 (e.g., via the application scanning service 103) can build a call graph from recognizable input application code, the assembly language obtained by disassembling binary input application code, or from source code obtained by decompiling binary input application code (in accordance with some aspects herein). As described above, the call graph can include namespaces, class names, and method names found within the code of the input application.

Furthermore, as shown in FIG. 4 at block 404 in the process 400, the application scanning service system 100 can identify at least one sub-graph associated with a data processing activity component namespace (e.g., an SDK namespace) that is included in a detector specification. For instance, the application scanning service system 100 can identify a match between a data processing activity component namespace (or other identifier) from a detector specification and a data processing activity component from the call graph. In addition, the application scanning service system 100 can utilize the matched data processing activity component from the call graph node to identify one or more sub-nodes connected to the matched data processing activity component in the call graph to generate one or more sub-graphs. Indeed, the application scanning service system 100 can identify sub-graphs having nodes connected to or labeled with namespaces that match namespaces found in one or more of the detector specifications.

Moreover, as shown in FIG. 4 at block 406 in the process 400, the application scanning service system 100 can traverse each sub-graph to identify nodes within the sub-graph that are associated with a class/method pair matching a class/method pair for a target data processing activity component (e.g., a target functionality) in the detector specification. For instance, for each sub-graph identified in the block 404, the application scanning service system 100 can traverse the sub-graph to identify one or more nodes labeled with a data processing activity component identifier (e.g., a class and/or method pair) matching a target data processing activity component in the detector specification (e.g., a target functionality, such as a class and/or method pair) based on the namespace of a parent data processing activity component. In some cases, upon detecting the class/method pair for a target functionality defined in a detector specification, the application scanning service system 100 can reference that detector specification to identify a data category (e.g., a data type or a purpose type) for the detected class/method pair in the data processing activity component namespace (e.g., an SDK namespace). Additionally, the application scanning service system 100 can also identify caller class and/or method pairs, i.e., methods (and their associated classes) that call the target functionality within the call graph and/or the detector specification (e.g., to determine a data category).

In some implementations, the application scanning service system 100 can utilize assembly mapping data to map sets of assembly language to corresponding caller classes and/or method pairs when assembly language is obtained by disassembling an input application. As an example, the application scanning service system 100 can identify map sets of assembly language having data processing activity components (e.g., caller classes and/or method calls) that match to detector specification entries. Then, the application scanning service system 100 can determine data categories and/or data processing activity components (to utilize in a scan report) from the map sets of assembly language.

In one or more cases, the application scanning service system 100 can reduce scanning time of an application code (e.g., improving the scanning speed and reducing the computing resources utilize to perform an application scan). In particular, in one or more aspects, the application scanning service system 100 utilizes a call graph to identify one or more sub-graphs, from matching data processing activity components in the detector specification (as described above). Moreover, upon identifying the one or more sub-graphs, the application scanning service system 100 scans the application code (and utilizes associated computing resources for the application scanning) for the subset of data processing activity components corresponding to the one or more sub-graphs (e.g., rather than searching and scanning an entire application code for target functionalities). Indeed, by scanning the one or more sub-graphs, the application scanning service system 100 reduces scanning time of an application code and also reduces the computing resources utilized to scan the application code.

In addition, upon identifying the one or more detected data processing activity components (e.g., via matching components from the call graphs and/or application code and the detector specification), the application scanning service system 100 can output the detected data processing activity components and one or more descriptive data for the data processing activity components. For example, the application scanning service system 100 can output data identifying the detected data activity processing component (e.g., SDK namespace and class/method pair) and the related data category (e.g., data type or purpose type) for the detected SDK component to update a software profile for an application code.

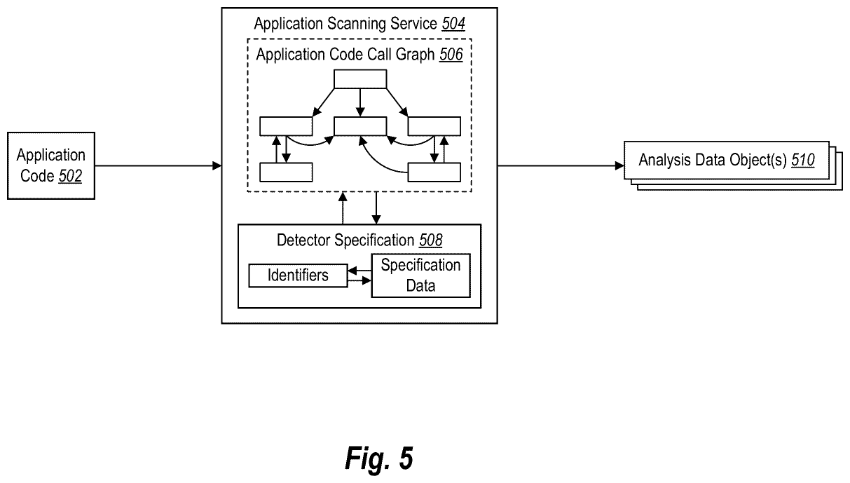

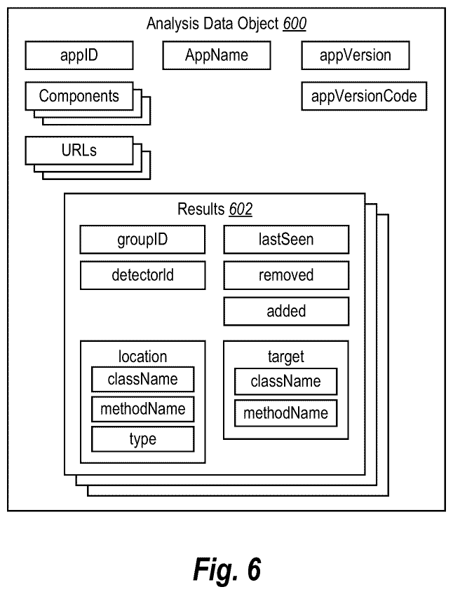

In some cases, the application scanning service system 100 generates analysis data objects that indicate a detected data processing activity component and various descriptive data (e.g., identifiers, sub-components, components, data categories, code locations, and/or modifications) from the detected data processing activity components as described below (e.g., in reference to FIGS. 5 and 6). For instance, FIG. 5 illustrates an example flow of the application scanning service system 100 determining analysis data objects (from detected data processing activity components).

For example, as shown in FIG. 5, the application scanning service system 100 utilizes an application code 502 with an application scanning service 504 (e.g., the application scanning service 103). As described above, the application code 502 can include a decompiled code, disassembled code, and/or a raw source code for an input application. Furthermore, as shown in FIG. 5, the application scanning service system 100 causes the application scanning service 504 to utilize the application code 502 (or an application code call graph 506 generated from the application code 502) with a detector specification 508 to detect data processing activity components and/or data categories for the input application (in accordance with some aspects herein).

For instance, as shown in FIG. 5, the application scanning service system 100 utilizes identifiers from the application code 502 with specification data in the detector specification 508 to determine matches (or mappings) for the data processing activity component identifiers (e.g., the identifiers). For example, the application scanning service system 100 can utilize namespaces detected within an application code to match with namespaces of detector specification entries in the detector specification 508. Furthermore, upon determining one or more matches with detector specification entries in the detector specification 508, the application scanning service system 100 can extract descriptive data from the detector specification entries (e.g., data categories, identifiers, code location, version data) for one or more data processing activity components to generate an analysis data object.

### Example of Analysis Object for Storing Scan Results

Indeed, as shown in FIG. 5, the application scanning service system 100 utilizes the detect data processing activity components and/or data categories for the input application (from the matching between the application code identifiers and the specification data) to generate an analysis data object(s) 510. For example, FIG. 6 illustrates an example of an analysis data object 600 generated by the application scanning service system 100 (in accordance with some aspects herein). In particular, FIG. 6 illustrates an example of an analysis data object 600 that can store scan results generated by the application scanning service system 100 (e.g., via the application scanning service 103) executing one or more of the processes described herein. As shown in FIG. 6, the analysis data object 600 includes a set of fields (e.g., descriptive data) describing the scanned input application. For instance, the application scanning service system 100 generates the analysis data object 600 with an appID field that can include a unique identifier by which the application scanning service 103 references an input application (e.g., a record number), an appName field that can indicate a name for the input application (e.g., a program name provided by a developer or other user of the application scanning service 103), an appVersion field that can identify which version of an input application was used to generate the set of scan results, and an appVersionCode field derived from the appVersion field.

As further shown in FIG. 6, the analysis data object 600 also includes one or more datasets (e.g., results 602), where each dataset includes instances of certain data processing activity components (e.g., features) detected in the input application code 110 via a scan by the application scanning service system 100 (as described above). For example, the analysis data object 600 can include a group of components and/or URLs indicating one or more data processing activity components detected in an application code. Indeed, the analysis data object 600 can, for each component and/or URL from the group of components and/or URLs, include a dataset (e.g., results 602) to include descriptive data for the components and/or URLs. Indeed, the results 602 can include datasets for SDKs, a URLs, and/or other data processing activity components.

As an example, the application scanning service system 100 can create an analysis data object 600 when a scan of an input application is initiated. For example, the application scanning service system 100 can cause the application scanning service 103 to create the analysis data object 600 in response to a scan command received as user input. Indeed, the application scanning service 103 can populate the fields for the analysis data object 600 from the scanned input application.

In some cases, the application scanning service system 100 can, via an interface for receiving the scan command, prompt a user to identify or confirm the application name and/or application version number. For example, the application scanning service system 100 can populate the appName field and the appVersion field in the analysis data object 600 based on such user input identifying or confirming the application name and/or application version number. In some implementations, the application scanning service 103 can populate the appVersionCode field by transforming the appVersion field value (e.g., “appVersion: 2.32.0”) into an integer or other format that simplifies comparison between application versions (e.g., “app VersionCode:28480”).

As an example, the application scanning service system 100 can generate an SDKs set from one or more SDK components. In particular, an SDK component (or element) can identify an SDK namespace encountered during the scan (by the application scanning service system 100). In this example, the application scanning service system 100 can generate each SDK component (or element) in response to detecting, in the input application code 110, an instance of an SDK namespace that is included in a detector specification. Each SDK component can include, for example, a key-value pair in which the key is “sdks” and the value is an SDK identifier (e.g., name, namespace, etc.) taken from the detector specification. Furthermore, the application scanning service system 100 can deduplicate the SDK set by, for example, iterating through the SDK set for an existing key-value pair with the SDK identifier before adding the SDK identifier or by removing duplicate key-value pairs after completion of the scan.

Furthermore, in some cases, the application scanning service system 100 can generate a URLs set from one or more URL components. Moreover, a URL component (or element) can identify a URL encountered during the scan (by the application scanning service system 100). In some implementations, the application scanning service system 100 can build a URL set that is a de-duplicated set of key-value pairs, in which each key is “urls” and the value is a URL or other network address (detected by the application scanning service system 100 within the application code).

Furthermore, as shown in FIG. 6, the application scanning service system 100 generates results 602 (e.g., results set) that includes one or more results elements. Indeed, in one or more instances, the application scanning service system 100 can generate result elements (e.g., the results 602) that include detection data describing a respective target functionality. For instance, the detection data can include descriptive data for a data processing activity component detected via a respective scan of the input application (e.g., data types, data processing purposes, functionality names, locations, comparison fields, detector specification data fields).

As shown in FIG. 6, the detection data (of the results 602) can include location data and/or target data elements (e.g., class names, method names, data types, functionality type, purpose type) for a particular data processing activity component (e.g., to describe a target functionality found in the scan). Moreover, as shown in FIG. 6, the application scanning service system 100 can also determine, and include as part of the results 602, detector identification fields (e.g., a groupID field and detectorID field) for a detector and detector group that include the data processing activity component (e.g., the target functionality). Additionally, as shown in FIG. 6, the application scanning service system 100 can determine, for a particular data processing activity component, one or more comparison fields (e.g., a lastSeen field, a “removed” field, and an “added” field) for the results 602.

In an illustrative example, the application scanning service system 100 can populate, based on scanning the input application code 110, the location and/or target data elements for the input application code 110. For instance, the application scanning service system 100 can identify target data elements (e.g., data types, descriptions, identifiers, data processing purposes) from a detector specification for a particular data processing activity component detected via the scan of the input application code 110. In some cases, the application scanning service system 100 also determines a location of the detected data processing activity component in the application code to associate the location with the target data elements (from the detector specification). In some implementations, the application scanning service system 100 determines the location of the particular data processing activity component from a call graph constructed for the scanned application code.

In some implementations, the application scanning service system 100 can populate the location and/or target data elements in a results element utilizing references to the target functionality found in a scan of the input application. For example, the target data element can include a className field identifying a class name for a target functionality (e.g., a data processing activity element) and a methodName field identifying a method name for the target functionality. The application scanning service system 100 can populate these fields by searching source code of the input application for the class/method pair of the target functionality.

In some cases, the application scanning service system 100 can determine a location data element that includes a className field and a methodName field respectively identifying the class and the method that call the target functionality within the input application. For instance, the application scanning service system 100 can populate the className and/or methodName fields by searching source code of the input application for the class/method pair that invoke the target functionality. Additionally, as shown in FIG. 6, the application scanning service system 100 can also include, within the location data element, a type field identifying a type of data collected by the target functionality, a purpose collected by the target functionality, or various other categorizations of the target functionality. The application scanning service system 100 can populate the type field by referencing a categorization for the target functionality defined in a detector specification (e.g., a categorization property for the target functionality, for the detector, and/or for the detector group). Although FIG. 6 illustrates the type filed as part of a location data element, in one or more aspects, the application scanning service system 100 can generate an analysis data object 600 with a type field for a data processing activity component (or target functionality) separate from the location data element.

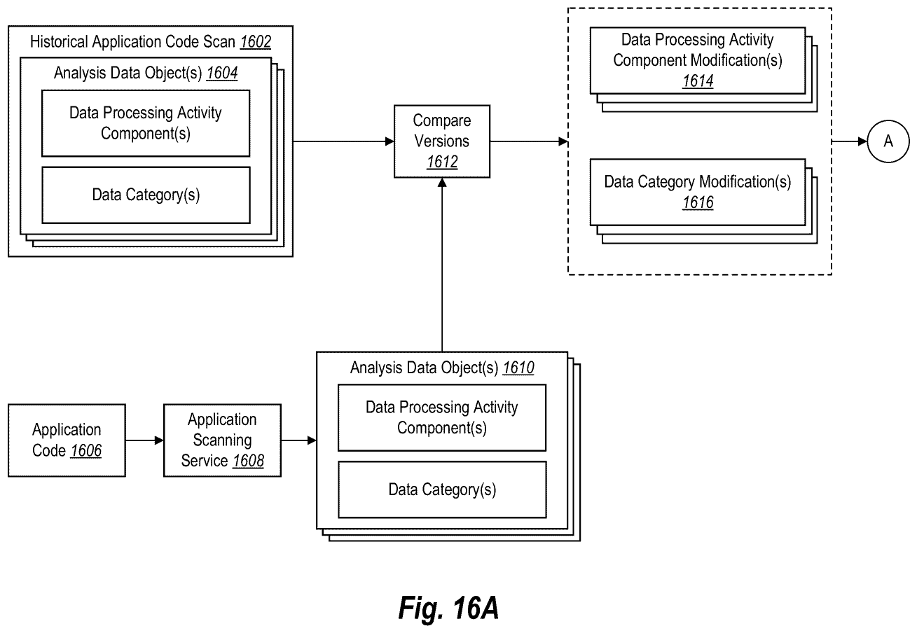

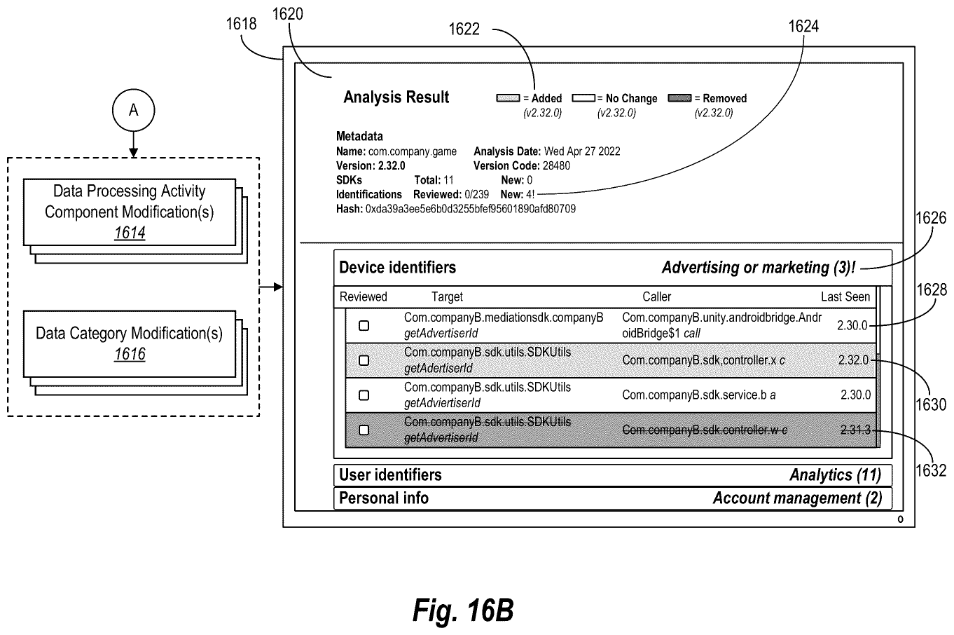

In some cases, the application scanning service system 100 generates the results 602 with comparisons fields. For example, the application scanning service system 100 can determine whether a data processing activity component is added in a version of an application code, removed in the version of the application code, and/or determine which version the particular data processing activity component was last seen. In some implementations, the application scanning service system 100 can leave the comparison field(s) blank when the result element is generated during a scan and can later populate the comparison field(s) by calling a set comparison process, such as the one described below (e.g., with reference to FIGS. 16-20).

Moreover, the application scanning service system 100 can populate a comparison field in a result element by comparing a given scan result to one or more other scan results in the scan result dataset. For instance, a lastSeen field can identify a most recent version number of an input application within the scan results in which a target functionality was detected. In FIG. 6, the lastSeen field can be identical for one or more result elements having the same className and methodName values (e.g., the same target functionality class/method pair). Furthermore, the “removed” field indicates whether the target functionality identified in a given result element was removed prior to the scanned version of the input application. For instance, the application scanning service system 100 can set the “removed” field to “true” if the target functionality was not detected in the scanned version of the input application (e.g., absent from version 2.32.1), but was detected in the immediately preceding version of the input application (e.g., present in version 2.32.0). Similarly, the “added” field can indicate whether the target functionality identified in a given result element was added prior to the scanned version of the input application. For instance, the application scanning service system 100 can set the “added” field to “true” if the target functionality was detected in the scanned version of the input application (e.g., present in version 2.32.1), but was not detected in the immediately preceding version of the input application (e.g., absent from version 2.32.0).

Furthermore, as shown in FIG. 6, the application scanning service system 100 can populate the detector identification fields from the applicable detector specification that includes the target functionality. For instance, the application scanning service system 100 can identify a detector identifier and/or detector group identifier in which the detector specification entry matched with a data processing activity component identifier from the application code. In one or more cases, the application scanning service system 100 associates the particular detector specification with the detected data processing activity component.

For instances, the application scanning service system 100 can populate the detector identification fields in a result element by referencing a detector specification. For instance, the detector specification can include a definition of a detector that includes one or more target functionalities, which are in turn defined using a class/method pair. The application scanning service system 100 (e.g., via the application scanning service 103) can match a class/method pair found in a source code scan to the class/method pair of the target functionality and the detector in the detector specification. The application scanning service 103 can populate the className and methodName fields of the target data element in the analysis object with the class/method pair from the detector specification. Furthermore, the application scanning service 103 can populate the detectorID field with an identifier of the detector from the detector specification. The application scanning service 103 can also populate the groupID field with an identifier of a detector group to which that detector belongs in the detector specification.

Indeed, in some cases, the application scanning service system 100 can determine a data categorization based on a utilized detector specification from a group of detector specifications. For instance, the application scanning service system 100 can match a particular data processing activity component (from an application code) to a detector specification entry within a particular detector specification (e.g., a detector group) associated with one or more data categorizations (e.g., data types, data purpose types). Indeed, the application scanning service system 100 can utilize the data categorizations associated with the particular detector specification as the data categorizations for the particular data processing activity component. As an example, the application scanning service system 100 can identify a detector specification that include data processing activity component identifier for location data processing functions. Moreover, in response to matching a data processing activity component from an application code to a detector specification entry from the location data processing detector specification, the application scanning service system 100 can associate the data processing activity component from an application code with a location processing data category.

### Example of Scan Report Outputted to User

As mentioned above, the application scanning service system 100 can generate dynamic graphical user interfaces with detected data processing activity components and data categories to enable quick and insightful access to a wide breadth of information from a performed application code scan. For example, FIG. 7 illustrates the application scanning service system 100 generating, for display within a client or computing device, a graphical user interface to display dynamic scan results from an application scan of an input application (or application code). For instance, the application scanning service system 100 generates, for display within a computing device 700, a graphical user interface 705 that includes a metadata section 701, an SDK detection section 702, a data category section 703, and a target detections section 704 for a scan of an input application (or application code).

As shown in FIG. 7, the application scanning service system 100 generates a graphical user interface with a metadata section 701 that displays information about a scan result and the scanned application. For instance, FIG. 7 depicts a scan result for an input application with the name “com.company.game,” particularly the version 2.32.0 of that input application. In some implementations, the application scanning service system 100 (e.g., via the application scanning service 103) populates the metadata section 701 from an analytics data object (as described above). For instance, the application scanning service 103 can populate this section from the appName, appVersion, and appVersionCode fields of an analytics data object described above with respect to FIG. 6.

In some cases, the application scanning service system 100 can generate a selectable menu interface element in the graphical user interface 705 (e.g., in the metadata section 701) for selecting different versions of the input application for which scan results are available. Indeed, upon receiving a user interaction with (or selection of) a particular version of the input application, the application scanning service system 100 can display, within the graphical user interface, scan results for the selected particular version. In some cases, the application scanning service system 100 can generate a menu interface element from a list of different appVersion values compiled from various analysis objects.

Furthermore, as shown in FIG. 7, the metadata section 701 also displays information about the total number of SDKs (e.g., groupings of data processing activity components) detected (or utilized) by the selected version of the input application and the number of “new” SDKs detected (or utilized) by the selected version of the input application. For instance, the application scanning service system 100 can use a “length” operator to determine the length of the SDK set in an analysis data object, and can populate the “SDKs . . . Total” field in the metadata section 701 with the output of the “length” operator.

Furthermore, the application scanning service system 100 can populate the field identifying “new” SDKs in metadata section 701 by executing a set comparison process, an example of which is described herein with respect to FIGS. 16-20. For example, as shown in FIG. 7, the application scanning service system 100 (via the set comparison process described below) can output a modified SDK set in which a grouping of SDK components added in a selected version of the input application are flagged as “added.” The application scanning service system 100 can count the number of these flagged SDK functions and use the number to populate the field identifying “new” SDKs in the metadata section 701.

As also shown in FIG. 7, the application scanning service system 100 displays information indicating the total number of SDK functions or target functions (e.g., data processing activity components) detected (or utilized) by the selected version of the input application and the number of “new” SDK functions or target functions detected (or utilized) by the selected version of the input application. For instance, the application scanning service system 100 can utilize a “length” operator to determine the length or number of a target functionality set in an analysis data object (e.g., a number of a results set in FIG. 6 or an issues set described herein). Moreover, the application scanning service system 100 can populate the “Identifications Reviewed” field in the metadata section 701 with the output of the “length” operator counting the number of target SDK functions.

Moreover, the application scanning service system 100 can utilize the set comparison process to obtain a modified set (e.g., a modified results set or modified issues set) in which target functionalities (e.g., SDK functions as data processing activity components) added in a selected version of the input application are flagged as “added.” As shown in FIG. 7, the application scanning service system 100 can populate the “Identifications . . . new” field with the number of added target functionalities. In some cases, the application scanning service system 100 can similarly display a number of “removed” target functionalities and/or removed target functionalities.

As further shown in FIG. 7, the application scanning service system 100 generates, for display within the graphical user interface 705, the SDK detection section 702. As illustrated in FIG. 7, the application scanning service system 100 displays, within the SDK detection section 702, a list of SDKs (e.g., groupings of data processing activity components) detected across different versions of the input application. For example, the application scanning service system 100 can display various SDKs to indicate various packages (or groups) of data processing components organized by a source SDK (or developer).

As an example, FIG. 7 illustrates the application scanning service system 100 displaying a first SDK detected in the application code (e.g., “Advertiser SDK”), a second SDK detected in the application code (e.g., “App Stats MAX SDK”), and a third SDK detected in the application code (e.g., “Social Media Component SDKs”). Indeed, the application scanning service system 100 displays the SDKs in the SDK detection section 702 to indicate overall groups for target functionalities detected in the application code. As further shown in the SDK detection section 702, the application scanning service system 100 displays when the particular SDK grouping was last seen in the application code. Indeed, the application scanning service system 100 can populate the SDK detection section 702 from the SDK set in an analysis data object. In some instances, the application scanning service system 100 can display SDKs detected in a particular version of an input application code.

Furthermore, the application scanning service system 100 can provide, for display within the graphical user interface 705, a data category section 703 that displays a list of data categories detected for the selected version of the input application. For example, the application scanning service system 100 can populate the data category section 703 by determining and displaying a set of categories (e.g., data types, data processing purpose types, SDK groupings, API groupings, developers, data processing activity component owners). For example, as shown in FIG. 7, the application scanning service system 100 displays, as a data category 706, an indication that the application code includes SDKs from “Social Media Company” (e.g., a developer or owner of one or more SDKs in the application code). Furthermore, as shown in FIG. 7, the application scanning service system 100 displays a count 708 of a number of SDK components detected for the data category 706.

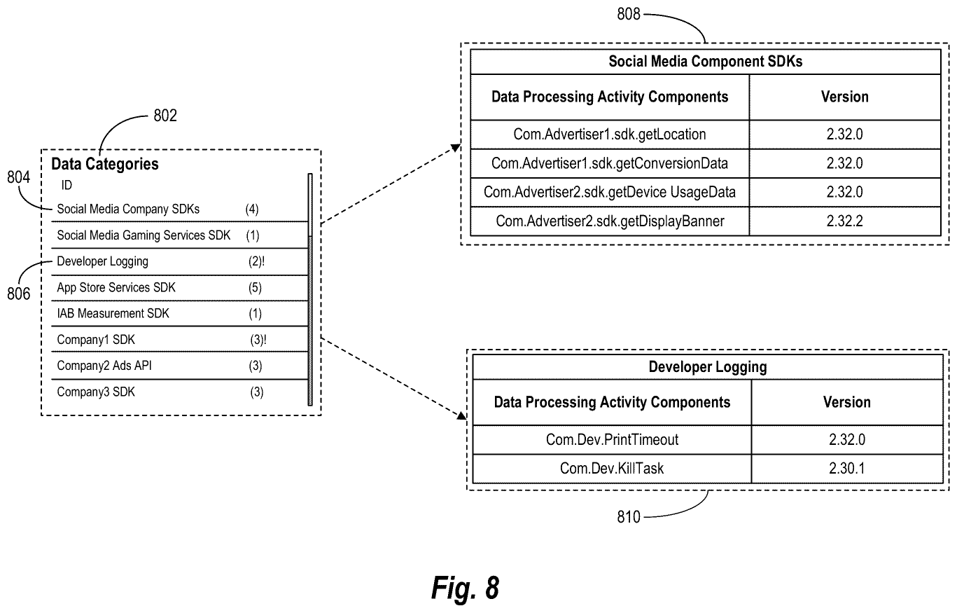

In one or more cases, the application scanning service system 100 generates the data categories displayed in the data category section 703 as selectable interface elements. Indeed, upon selection (e.g., user selection) of a data category within the data category section 703, the application scanning service system 100 can display one or more data processing activity components from the application code (for the selected data category) in the target detections section 704. For example, displaying selectable interface elements for data categories is described in greater detail below (e.g., in reference to FIG. 8).

As further shown in FIG. 7, the application scanning service system 100 can provide, for display within the graphical user interface 705, indicators to represent changes in components for one or more data categories in the data category section 703. As illustrated in FIG. 7, the application scanning service system 100 displays an indicator 710 to indicate a change in a number of data processing activity components detected in an application code for a particular data category (e.g., “Searcher Mobile Ads API” category). Indeed, the application scanning service system 100 can display various indicators for the data categories to indicate changes in data categories and/or an addition of new data category detected within a version of the application code.

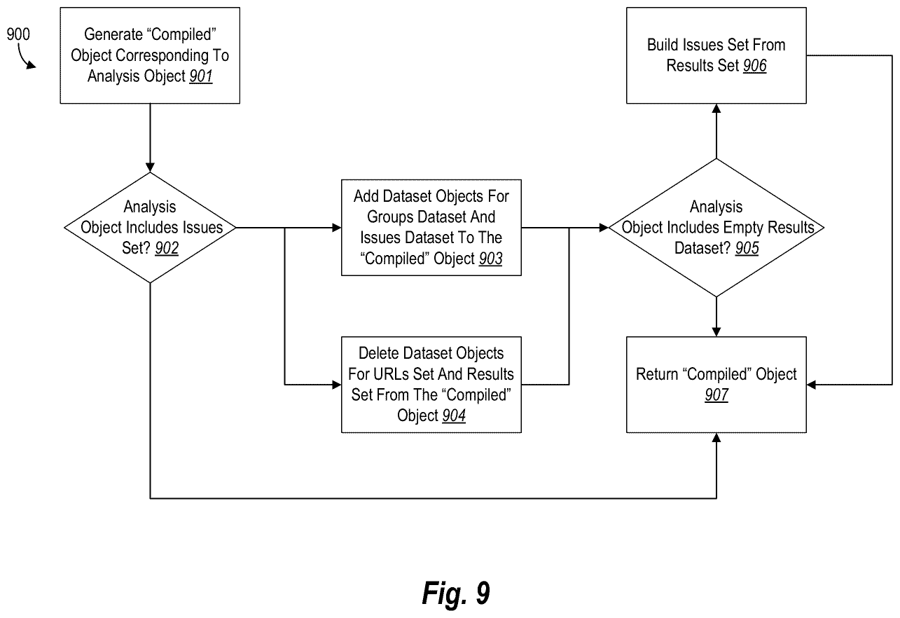

In some cases, the application scanning service system 100 populates the data category section 703 by detecting (and organizing) data category types indicated in an analysis data object (as described above). In one or more aspects, the application scanning service system 100 populates the data category section 703 by building, from an issues set described herein (e.g., in reference to FIGS. 9-15), a set of category elements. For example, each category element can identify a detector or detector group, which is populated using the “name” defined for the detector or detector group in a detector specification, and a number of issue elements having the detector identifier or the detector group identifier defined in the detector specification.

Furthermore, as shown in FIG. 7, the application scanning service system 100 provides, for display within the graphical user interface 705, a target detections section 704. In particular, as illustrated in FIG. 7, the application scanning service system 100 displays, within the target detections section 704, a hierarchical list of data categories and target functionalities from the current scan result. For instance, as shown in FIG. 7, the application scanning service system 100 can display, within the target detections section 704, a data category 712 (e.g., a purpose type of “advertising or marketing” for processing a data type of “device identifiers”) detected in the application code and the target functionalities 714 (e.g., data processing activity components) that are present in the application code that fall under the data category 712.

Indeed, as shown in the target detections section 704, the first level of the hierarchy includes data categories found in the scan results (with a version indicator for the application code version the data categories were found in). Additionally, as shown in the target detections section 704, the application scanning service system 100 can build the first level from a unique “type” field value in a result or issues set (as described herein). Moreover, as illustrated in the target detections section 704, the application scanning service system 100 can display a second level of the hierarchy that includes, for each data category, the target functionalities (e.g., data processing activity components) for that data category found in the scan results.

For example, the application scanning service system 100 can build the second level of hierarchy by populating, in the rows under each unique “type” field value in an issues (or results) set, detection data (e.g., target functionality class/methods, caller class/methods, last seen values) from the issues (or results) elements having that “type” field value. For instance, the application scanning service system 100 can utilize issue elements having a “Device Identifiers” type to populate the rows under the “Device Identifiers” heading in target detections section 704. As further shown in FIG. 7, the application scanning service system 100 can display closed hierarchical data categories (e.g., data category 720) and, upon receiving a user interaction with the closed hierarchical data categories, can expand the closed hierarchical data categories to display one or more data processing activity components for the closed hierarchical data categories.

In one or more aspects, the target detections section 704 identifies, for each target functionality, a caller class/method. For example, the application scanning service system 100 can intelligently determine and dynamically display the data categories and target functionalities detected in an application scan to provide improved insight (or an improved useful explanation) of how the input application collects data in certain data categories or for certain purposes (even when the application may have thousands or millions of lines of code). In some cases, the application scanning service system 100 can enable one or more systems to utilize the detection of data categories and/or the generated dynamic graphical user interface for modifying the operation of an input application if, for example, unexpected target functionality or data category processing is detected by the application scanning service. For instance, a software development tool operated by a user can be used to modify code of the input application based on a scan result. In some implementations, the application scanning service system 100 enables an application deployment platform system to scan and review an application for unexpected target functionality or data category processing prior to deploying the application. Additionally, the application scanning service system 100 can also enable an application deployment platform system to display the detected data categories as information within an application store to notify users of the target functionality or data category processing in an application prior to installing an application.

Additionally, as shown in FIG. 7, the application scanning service system 100 can also display a comparison scan result (e.g., the scan result for the immediately preceding version number) within the graphical user interface 705 (e.g., in the target detections section 704). Indeed, the application scanning service system 100 determining and displaying comparison scan results is described in greater detail below (e.g., in reference to FIGS. 16-20).

In one or more instances, the application scanning service system 100 can generate graphical user interface elements that provide data visualizations for the application scan results. For example, the application scanning service system 100 can display a chart and/or graph that includes data processing activity components and/or data categories detected in an application scan (as described herein). For instance, the application scanning service system 100 can generate a data visualization, via a graph and/or chart, that indicates one or more SDKs detected within an application code. Furthermore, the application scanning service system 100 can, via the graph and/or chart, indicates, for each of the one or more SDKs, one or more data categories (e.g., data types, purpose of data processing) processed by the SDK(s). In some cases, the application scanning service system 100 can also, via the graph and/or chart, indicate one or more classes and/or methods that correspond to the SDK(s) and/or one or more data categories associated with the SDK(s). Indeed, the application scanning service system 100 can facilitate navigation to (or detection) of specific class and/or method calls that collect and/or share data from a particular data category (e.g., highly sensitive data types, sensitive data types, non-sensitive data types).

In some aspects, the application scanning service system 100 can generate the user interface 705 utilizing data objects that store, for each scan result, lists of unique SDK namespaces, unique target functionalities, and/or unique data categories. In an illustrative example, the application scanning service system 100 can generate a scan result as JSON object. For instance, the application scanning service system 100 can create an SDK array by parsing the JSON object and adding an element to the array for each newly encountered SDK namespace in the JSON object. Indeed, in one or more instances, the application scanning service system 100 generates a single array element identifying an SDK namespace for multiple occurrences of a given SDK namespace. Furthermore, the application scanning service system 100 can create a target array by parsing the JSON object and adding an element to the array for each newly encountered target functionality in the JSON object.

In some instances, the application scanning service system 100 can generate, as a scan result, an exportable data type report which summarizes one or more data processing activity components (e.g., SDKs) and one or more associated data categories within an exportable spreadsheet (or other data table) file. Indeed, the application scanning service system 100 can transmit the exportable data type report to various other application code platforms (e.g., developer computing system, a source code management system, and/or a software deployment platform). For example, the application scanning service system 100 can generate an exportable data type report, for a scan report on an input application (e.g., eStore_music), as shown in Table 3 (below). Although Table 3 illustrates an exportable data type report with a specific number of data processing activity components, the application scanning service system 100 can generate an exportable data type report with a varying number of data processing activity components (and corresponding data type categories).

TABLE 3
Data Type Report Example

| Name: eStore_music | |
|---|---|
| Package name: com.eStore.mp3 | |
| Version: 23.12.1 | |
| Review the types of data collected by | |
| SDKs detected in your app. | |
| SDK | Data Types collected . . . |
| eStore Mobile Ads SDK | Apps on Device, Device ID |
| PhoneOS MediaAPI | Other App Activity, Performance Diagnostics |
| PhoneOS Person API | Name |
| PhoneOS Webkit Mime TypeMap API | Files and Docs |
| PhoneOS WiFiManager | Other Performance |
| Dev1 | Other App Activity, Performance Diagnostics, |
| SDK | Device ID |
| Bug Crash Reporting | User Account, Name, Email |
| VideoPlayer Mediplayer API | Videos |
| TaskManager Remove Config SDK | Other Performance |
| Company1 Auth API | Other App Activity, User Account, Name |

As mentioned above, the application scanning service system 100 can generate and display data categories as selectable interface elements. For instance, FIG. 8 illustrates the application scanning service system 100 displaying selectable data categories. In particular, FIG. 8 illustrates the application scanning service system 100 displaying a dynamic graphical user interface that displays different sets of data processing activity components based on user interactions with one or more selectable data categories in a graphical user interface.

For example, as shown in FIG. 8, the application scanning service system 100 displays a data category section 802 indicating data categories detected within an application code (in accordance with some aspects herein). Furthermore, in reference to FIG. 8, the application scanning service system 100 displays the data categories in the data category section 802 as selectable user interface elements. Furthermore, upon receiving a user selection of a data category, the application scanning service system 100 can display one or more data processing activity components from the input application that correspond to the selected data element.

Indeed, as shown in FIG. 8, upon receiving a user interaction with a selectable user interface element 804 (e.g., a non-visible selection box, a radio button, a button) corresponding to a data category “Social Media Company SDKs,” the application scanning service system 100 provides, for display within a graphical user interface of a computing device, a target detections section 808. Indeed, as shown in FIG. 8, the application scanning service system 100 displays the target detections section 808 to indicate data processing activity components (e.g., target functionalities or SDK components) from the application code (for the selected data category of “Social Media Company SDKs”) in the target detections section 808. Likewise, as shown in FIG. 8, upon receiving a user interaction with a selectable user interface element 806 (e.g., a non-visible selection box, a radio button, a button) corresponding to a data category “Developer Logging,” the application scanning service system 100 provides, for display within a graphical user interface of a computing device, a target detections section 810. For instance, as illustrated in FIG. 8, the application scanning service system 100 displays the target detections section 810 to indicate data processing activity components (e.g., target functionalities or SDK components) from the application code (for the selected data category of “Developer Logging”) in the target detections section 810. Indeed, the application scanning service system 100 can display various sets of data processing activity components based on a user selection of various data categories.

### Example of Compile Process to Generate Issues Set

In one or more aspects, the application scanning service system 100 can compile results from an analysis data object to generate issue elements to display one or more user interface elements for various data, such as, but not limited to data processing activity components, data categories, comparison results (e.g., modifications), and/or application metadata. In particular, the application scanning service system 100 can generate an analysis data object (as described above) for an application code scan. Moreover, upon compiling the results from the analysis data object to generate an issues set, the application scanning service system 100 utilizes the issues set to populate a graphical user interface to display data scanned from the application code.

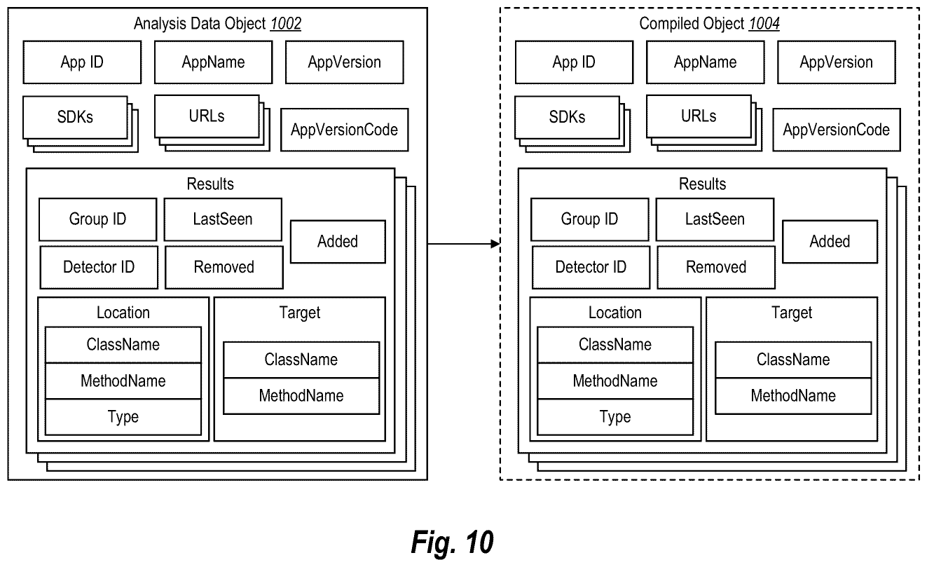

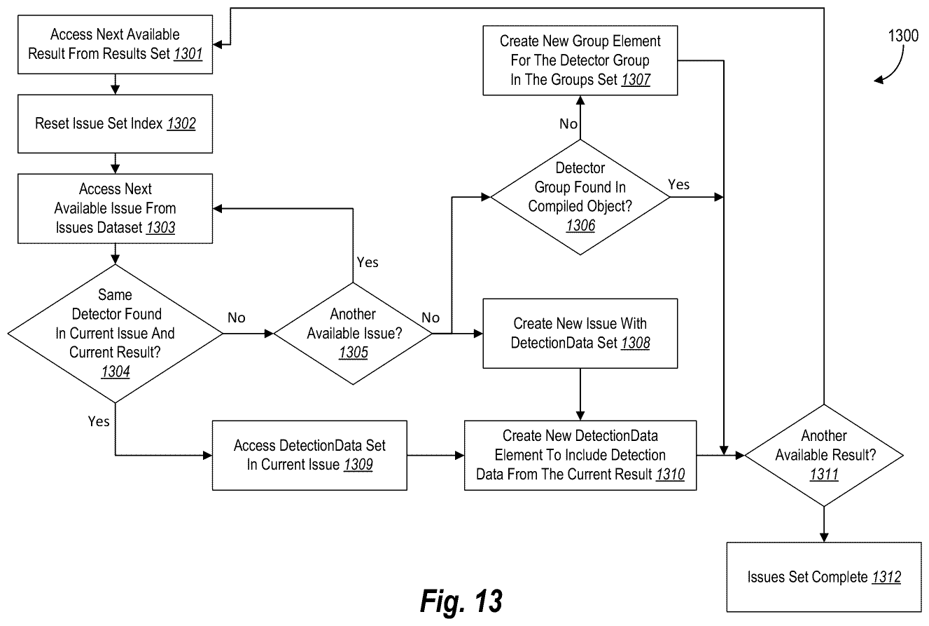

Indeed, the application scanning service system 100 can execute a compile process to compile results, such as a Results set depicted in the analysis data object of FIG. 6, into issue elements that can be used to populate various sections of the graphical user interface 705 (e.g., the metadata section 701, the SDK detection section 702, the data category section 703, and the target detections section 704). Indeed, the application scanning service system 100 implementing the compile process is described herein with respect to the process 900 depicted in FIG. 9, the process 1300 depicted in FIG. 13, and various examples depicted in FIGS. 10-12, 14, and 15. In these examples, the application scanning service system 100 transforms a Results set for an analysis data object into an Issues set.

As shown in FIG. 9, in some implementations, the application scanning service system 100 generates a temporary Compiled object as part of the compile process, as depicted at block 901 of the process 900. For example, the application scanning service system 100 (e.g., via the application scanning service 103) generates the Compiled object by converting the analysis object into a string, and parsing the string into a suitable data object (e.g., a JavaScript object). Thus, as depicted in FIG. 10, the Compiled object 1004 as initially created includes fields, sets, and values that are identical (or nearly identical) to the those found in the analysis data object 1002.

Additionally, in some implementations, the application scanning service system 100 can check for an existing Issues set, as depicted at block 902. For instance, the application scanning service system 100 checks whether the analysis object includes an issues set (during the compile process) because, if the Issues set is present in the analysis object, a Results set has already been compiled for the current version of the input application.

For example, in some cases, the application scanning service system 100 can determine that an Issues set already exists when the compile process 900 is already performed for the analysis data object. For instance, in some implementations, the application scanning service system 100 can replace an analysis data object with a corresponding Compiled object. Indeed, the application scanning service system 100 can replace the analysis data object with a corresponding Compiled object via a command that sets the value of an analysis data object to the output of an instance of the compile process, where the instance of the compile process receives the analysis object as an input. In this example, the resulting analysis data object would include the Issues set. Thus, in a subsequent invocation of the compile process with the same analysis data object, the application scanning service system 100 can output that analysis data object without changes (i.e., because the Issues set is included in the analysis data object).

In one or more aspects, as shown in FIG. 9, if the Issues set is detected at the block 902, the application scanning service system 100 (via the compile process 900) can output the Compiled object at block 907. Otherwise, as shown in FIG. 9, the application scanning service system 100 (via the compile process 900) can continue utilizing the Compiled object. For example, as shown in FIG. 9 at block 903, the application scanning service system 100 can continue the compile process 900 by creating, in the Compiled object, dataset objects (e.g., arrays) for a Groups set and an Issues set (e.g., by adding dataset objects for a groups dataset and an issues dataset to the “compiled dataset”).

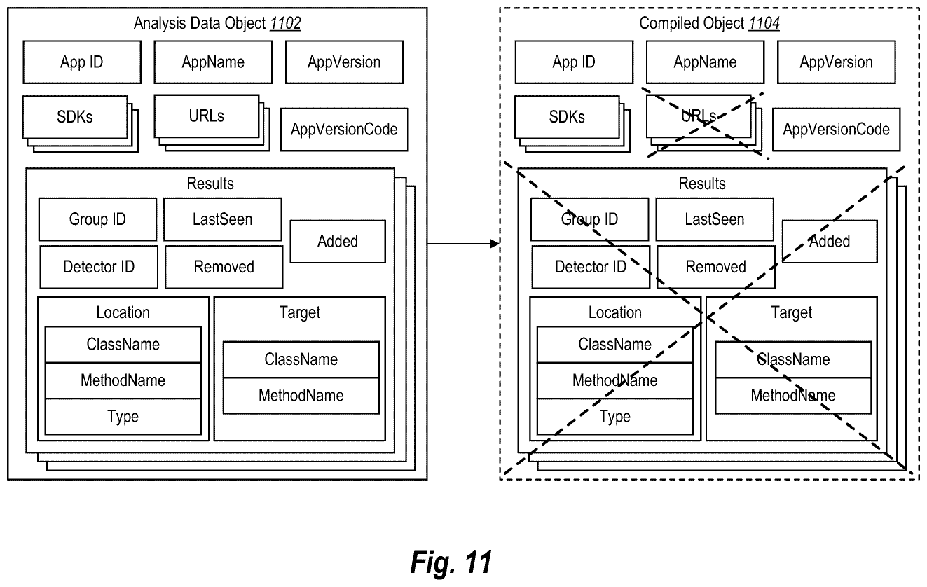

In some implementations, the application scanning service system 100 can also delete, from the Compiled object, dataset objects for the URLs set and the Results set, as shown in block 904. For example, the application scanning service system 100 can delete dataset objects to generate a compiled object 1104 from an analysis data object 1102 (as shown in FIG. 11. For example, as shown in the compiled object 1104 of FIG. 11, the application scanning service system 100 generates the Compiled object 1104 to include dataset objects Groups and Issues with the URLs set and Results set deleted.

In some implementations, as shown in the compile process 900, the application scanning service system 100 can determine whether the analysis object from which the Compiled object was created includes an empty Results dataset, as depicted at block 905. For instance, the application scanning service system 100 can checks for an empty Results dataset because the absence of the Results set indicates that zero target functionalities were found during the associated scan on the input application. If the Results set is empty, the application scanning service system 100 (via the process 900) can output the Compiled object at block 907. Otherwise, the application scanning service system 100 (in the compile process 900) continues to block 906. In some cases, the application scanning service system 100 can check the Compiled object for an empty data set.

Additionally, as shown in block 906, the application scanning service system 100 can (via the compile process 900) build an Issues set from the Results set (of the analysis data object). Furthermore, at the block 907, the application scanning service system 100 can, in the compile process 900, output the Compiled object with the Issues set generated at block 906. Indeed, the application scanning service system 100 can generate an Issues set as described below (e.g., in reference to a process 1300 for building an Issues set as depicted in FIG. 13).

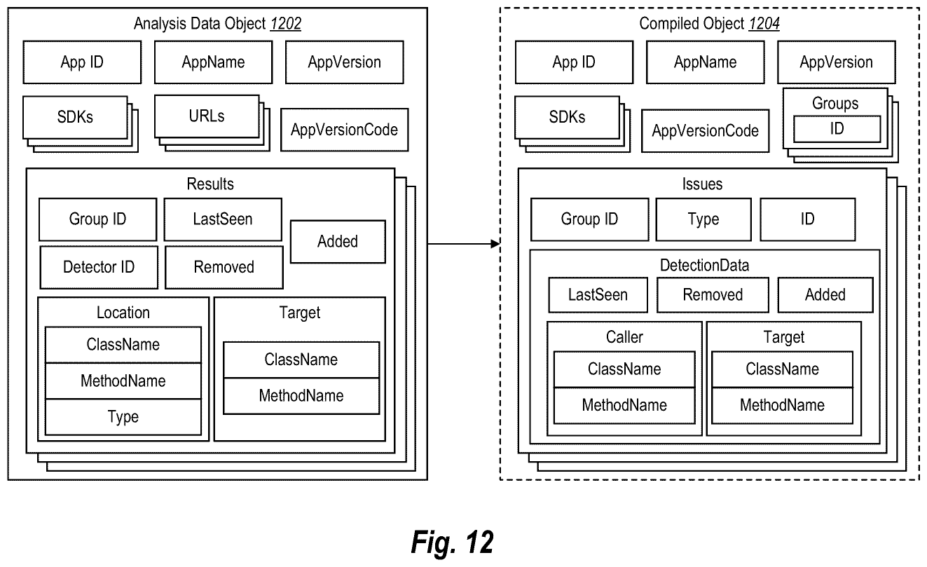

For example, the application scanning service system 100 can create an Issues set in the “compile” object by iterating through each element of the Results set (of the analysis data object). In particular, the set of iterations modifies the Compiled object 1204 (and/or the analysis data object 1202) to include the Issues set depicted in FIG. 12. In this example (of FIG. 12), each Issue element of the issues dataset in the compiled object 1204 includes issue identification fields, such an id field identifying a detector defined in a detector specification, a gid field identifying a detector's detector group as defined in a detector specification, and a type field identifying a type of data falling within a data category identified in a detector specification. Furthermore, as shown in FIG. 12, the Issue element also includes a DetectionData set, where each DetectionData element of the DetectionData includes data found during a scan regarding a specific target functionality included in the detector identified via the “id” field.

Additionally, as mentioned above, the application scanning service system 100 can generate an Issues set from a results set (of an analysis data object). For example, FIG. 13 illustrates an example of the application scanning service system 100 generating an Issues set. In particular, FIG. 13 illustrates a process 1300 of the application scanning service system 100 generating an Issues set by iterating through each Result in the Result set from an analysis data object.

As illustrated in FIG. 13 at block 1301 of the process 1300, the application scanning service system 100 can begin an iteration by retrieving or otherwise accessing a next available Result element from the Results set of an analysis data object. In some implementations, the application scanning service system 100, in the process 1300, can create a control variable for determining whether to proceed to a next iteration. For instance, in an iteration for a Result r, the application scanning service system 100 can initially set a control variable to a value that is not a proper array index value (and/or a null value).

Additionally, the application scanning service system 100 can iteratively search a Compiled object for an issue element corresponding to a particular detector as part of the process 1300. For example, at block 1302, the application scanning service system 100 resets an index for the Issue element so that the iterative process starts with a first Issue element in the Issue set. Moreover, at block 1303, the application scanning service system 100 can retrieve (or access) the Issue element at the current index for the Issue set. At block 1304, the application scanning service system 100 can compare a detector identified in the current Issue element with the detector identified in the current Result (e.g., Result r).

If, at block 1304, the application scanning service system 100 determines that the Issue element and the Result element identify the same detector (e.g., matching values for the detectorID field in the Result and the id field in the Issue element), the application scanning service system 100 can proceed to the block 1309 to access a DetectionData set for the current Issue element. For instance, the application scanning service system 100 (e.g., via the application scanning service 103) can search each issue element for an issue identifier that identifies the particular detector, such as a value of the ID field in the issue element matching a value of the detectorID field for scan result r. If this search results in a match, the application scanning service system 100 can set the control variable to an index value that prevents addition of a new Issue element to the Compiled object (e.g., by skipping the logic implementing blocks 1305 and 1308 in FIG. 13). For instance, the application scanning service system 100 can set the control variable (e.g., found) to the index of the Issue element (e.g., found=cr) with an ID value matching the detector for the Result r. In some aspects, the application scanning service system 100 sets the control variable to the current Issue element's index to enable referencing of the current Issue element (i.e., Issue element for the detector) when executing logic implemented by block 1310 (to update the DetectionData set of the current Issue element).

Alternatively, if the application scanning service system 100 determines at block 1304 that the Issue element and the Result element do not identify the same detector (e.g., the detectorID field value for the Result is not found in the ID field for the Issue), the application scanning service system 100, in the process 1300, can iterate to the next available Issue element in the Issue set, as shown via the check for another available Issue element in block 1305 and the retrieval of the next available Issue element in block 1303.

Moreover, in some implementations, if no other Issue element is available at block 1305 (e.g., the application scanning service system 100 has iterated through the entire Issue set without finding the detector in the current Result r) the process 1300 proceeds to block 1306. For example, at block 1306 in the process 1300, the application scanning service system 100 can search the Compiled object for a detector group to which the detector belongs. For instance, the application scanning service system 100 can identify a detector group from the groupId of Result r. Moreover, the application scanning service system 100 can search each Group element in the Groups set of the Compiled object for an ID field value matching the groupId field value from Result r.

Furthermore, if a Group element for the detector group does not exist in the Groups set of the Compiled object (e.g., a negative response at the block 1306), the application scanning service system 100 can update the Groups set to add a Group element identifying the detector group, as depicted in block 1307. For instance, the application scanning service system 100 can update the Groups set of the compiled object to include a Group element having an ID value matching the groupId field value of the Result r.

Alternatively, if a Group element for the detector group already exists in the Groups set of the Compiled object (e.g., a positive response at the block 1306), the application scanning service system 100 can add a new Issue element to the Issue set without modifying the Groups set. For example, the application scanning service system 100 adding a new Issue element to the Issue set without modifying the Groups set is depicted in FIG. 13 by showing parallel flows following block 1305. For example, these parallel flows from FIG. 13 can be implemented by, for example, the application scanning service system 100 setting the control variable (e.g., found) to a value that causes the application scanning service 103 to skip over logic that modifies the Groups set (e.g., at the block 1308).

If no other Issue element is available at block 1305 (e.g., the application scanning service system 100 has iterated through the entire Issue set without finding the detector in the current Result r), the process 1300 proceeds to block 1308. For example, at block 1308, the application scanning service system 100 can create a new Issue element in the Compiled object, where the new Issue element includes a dataset object for a new DetectionData set. For instance, the application scanning service system 100 can create a new Issue element in which the gid field is set to the groupId field value from the Result r, the id field is set to the detectorId field value from the Result r, and the type field is set to the type field value for the location element from the Result r.

Moreover, the process 1300 can proceed to block 1310 in which the application scanning service system 100 can utilize the DetectionData set for the new Issue element. For instance, the application scanning service system 100 can set the control variable (e.g., found) to the index of the new issue element (e.g., found=compiled.issues.length−1). Indeed, the application scanning service system 100 can set the control variable to the Issue element's index value to enable the process 1300 to reference the newly created Issue element for the detector from Result r when executing logic that implements block 1310.

For example, at block 1310, the application scanning service system 100 can create a new DetectionData element in the DetectionData set. Indeed, in some cases, the DetectionData set can be an empty DetectionData set from the Issue element created at block 1308 or the DetectionData set accessed at block 1309 (by the application scanning service system 100). Furthermore, the application scanning service system 100 can populate the new DetectionData element with relevant detection data from the Current Result r.

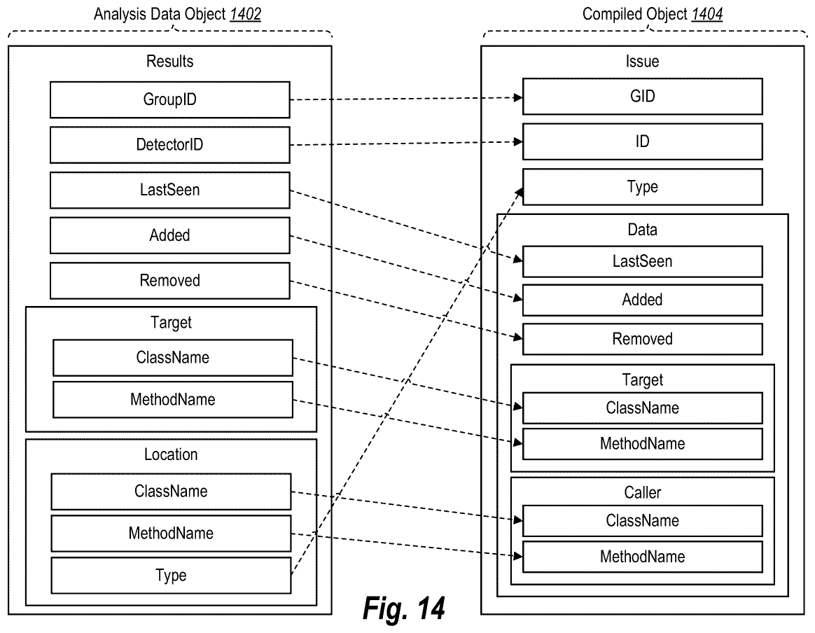

FIG. 14 illustrates an example summarizing a relationship between a Result r, a current Issue element, and a DetectionData element updates at block 1310. In FIG. 14, unidirectional arrows indicate which field values from a result r (from an analysis data object 1402) are copied, by the application scanning service system 100, to a corresponding Issue and DetectionData element (in the Compiled object 1404). In this manner, the application scanning service system 100, as part of the compiling process, can replace a set of multiple result elements identifying the same detector group, detector, and type with a single issue object having associated detection data set with target functionality information (e.g., caller, last seen, added/removed flag, etc.).

For instance, at block 1310 in FIG. 13, the application scanning service system 100 can populate the new DetectionData element with relevant target functionality information from Result r. In some cases, the application scanning service system 100 can populate the new DetectionData element by copying the values of the caller class and method fields from the Result r to the values of the target class and method fields in new DetectionData element.

At block 1310, the application scanning service system 100 can also update the new DetectionData element with values of the lastSeen, added, and “removed” fields. For instance, the application scanning service system 100 can determine if the Result r includes a value for the lastSeen field. If the value for the lastSeen field exists in Result r, the application scanning service system 100 can update the lastSeen field in the new DetectionData element to the application version number stored in the lastSeen field from the Result r. Otherwise, the application scanning service system 100 can update the lastSeen field in the new DetectionData element to the application version number stored in the appVersion field of the analysis data object that includes scan result r. The application scanning service system 100 can also determine if the scan result r includes a “true” value for the “removed” field. If the scan result r includes a “true” value for the “removed” field, the application scanning service system 100 can set the “removed” field in the new element to a “true” value. Otherwise, the application scanning service system 100 can leave the “removed” field in the new element with a default “false” value or set the “removed” field to a “false” value. In some instances, the application scanning service system 100 also determines if the scan result r includes a “true” value for the “added” field. If the scan result r includes a “true” value for the “added” field, the application scanning service system 100 sets the “added” field in the new element to a “true” value. Otherwise, the application scanning service system 100 can leave the “added” field in the new element with a default “false” value or sets the “added” field to a “false” value.

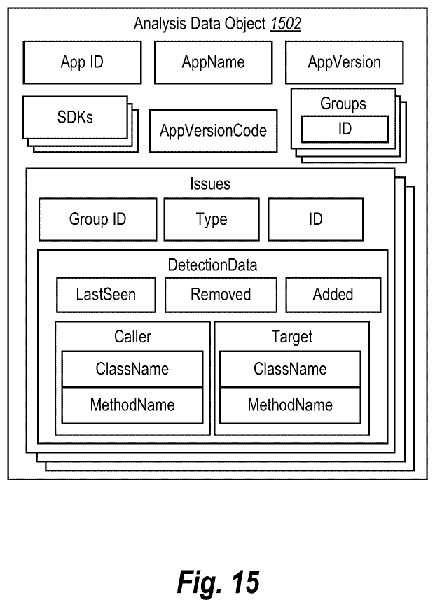

Furthermore, at block 1311, the application scanning service system 100 can check for another available Result from the analysis object. Upon identifying another available Result, the application scanning service system 100, proceeds to block 1301, with the available Result. Otherwise, if the application scanning service system 100 has iterated through the entire Result set, the Issues set is complete, as shown in block 1312. The process 1300 can provide the Issue set to process 900, in which the application scanning service system 100 can output the Compiled object having the Issues set. In some implementations, the analysis data object utilized to build the “compile” object is replaced with the “compile” object, as depicted in FIG. 15 (e.g., the analysis data object 1502).

In some implementations, the application scanning service system 100 can utilize an analysis data object with an Issues set to automatically generate data to be uploaded to online environments that audit input applications before making the input applications available for download. For instance, an online environment for distributing mobile applications (e.g., an application deployment platform system) may require completion of a questionnaire or other assessment regarding data categories and purposes for data collected by each mobile application. Manually completing such questionnaires can result in errors or inaccuracies. The application scanning service system 100 provides a practical application that intelligently determines data categories and/or data processing activity components to mitigate this problem by auto-generating a table (e.g., a spreadsheet, a set of comma-separated values, etc.) of questionnaire answers to be uploaded. In an illustrative example, the application scanning service system 100 can generate a template table that includes a first column in which each row identifies a data category or purpose found in one or more detector specifications used to generate an analysis data object and a second column that indicates whether an input application collects data for that data category or purpose. Furthermore, the application scanning service system 100 can build an output table by creating a copy of the template table, updating rows in the second column to a “true” value (or leaving a default “true” value unchanged) if the identified data category or purpose matches a “type” value for an Issue element in the Issues set, and updating rows in the second column to a “false” value (or leaving a default “false” value unchanged) if the identified data category or purpose fails to match the “type” value for any of the Issue elements in the Issues set.

### Example of “Compare Results” Process

As mentioned above, the application scanning service system 100 can determine changes of data processing activity components and/or data categories detected between scans of different versions of the application code. For example, FIG. 16A illustrates the application scanning service system 100 determining changes of data processing activity components and/or data categories detected between scans of different application code versions. In addition, FIG. 16B illustrates the application scanning service system 100 providing, for display within a graphical user interface, a scan report for an application code that indicates changes of data processing activity components and/or data categories detected between application code versions.

For example, as shown in FIG. 16A, the application scanning service system 100 utilizes the application scanning service 1608 with an application code 1606 to generate analysis data object(s) 1610. Indeed, as shown in FIG. 16A, the analysis data object(s) 1610 includes a data processing activity component(s) and/or a data category(s). Indeed, the application scanning service system 100 can generate the analysis data object(s) 1610 (via a scan) in accordance with one or more embodiments herein.

Furthermore, as shown in FIG. 16A, the application scanning service system 100 identifies a historical application code scan 1602 (e.g., a scan of a previous version of the application code). As part of the historical application code scan 1602, the application scanning service system 100 identifies an analysis data object(s) 1604 that includes data processing activity component(s) and data category(s) for the historical application code scan 1602. Moreover, as shown in an act 1612 of FIG. 16A, the application scanning service system 100 compares the application code versions via the analysis data object(s) 1604 of the historical application code scan 1602 and the analysis data object(s) 1610 (e.g., from a current version of the application code). Indeed, as shown in FIG. 16A, the application scanning service system 100 determines (or generates) the data processing activity component modification(s) 1614 and the data category modification(s) 1616 from the comparison in the act 1612.

As used herein, the term “data processing activity component modification” refers to a change corresponding to a particular data processing activity component (between versions of an application code and/or due to an update from the data processing activity component source). In particular, a data processing activity component modification can include a change in content, data type, and/or functionality of a data processing activity component. In addition, a data processing activity component modification can include an addition and/or removal of a data processing activity component from an application code. In one or more aspects, the data processing activity component modification can result from a modification of an application code in between versions of the application code. In some aspects, a data processing activity component modification can include a change in a definition, functionality, and/or data type associated with a data processing activity component based on changes to the component via a developer and/or source of the data processing activity component modification (e.g., an update in an SDK library, API, and/or function call).

As used herein, the term “data category modification” refers to a change corresponding to a data category represented within an application code (between versions of an application code and/or due to an update from the data processing activity component source). For example, a data category modification can include a change in one or more data categories associated within an application code. For instance, the application scanning service system can detect an addition and/or removal of a data processing activity component and, in turn, detect a new data category exists for the application code (due to an addition) and/or detect that an existing data category no longer applies to the application code (due to a removal) as a data category modification. In some aspects, the application scanning service system can detect that a change in a definition, functionality, and/or data type associated with a data processing activity component (present in the application code) which results in a removal and/or addition of a data category for the data processing activity component (as a data category modification).

In one or more instances, the application scanning service system 100 compares the analysis data object(s) between the application code scans of the application code versions. Indeed, the application scanning service system 100 can compare the analysis data object(s) to identify changes in the data processing activity components (e.g., an addition and/or removal of a data processing activity component) as data processing activity component modification(s) 1614. Moreover, the application scanning service system 100 can flag the changes in the data processing activity components between the application code versions (i.e., between the analysis data object(s) of the prior version of the application code and a current version of the application code). In addition, the application scanning service system 100 can determine (or track) a total number of added and/or removed data processing activity components between the application code versions.

Furthermore, as shown in FIG. 16A, the application scanning service system 100 can generate data category modification(s) 1616 from a comparison of analysis data object(s) between the application code scans of the application code versions. For instance, the application scanning service system 100 can utilize changes in data processing activity component(s) between application code versions to detect changes in data categories. For example, the application scanning service system 100 can determine, as a data category modification, that a new data category corresponds to the application code (due to an addition of one or more data processing activity components). In some cases, the application scanning service system 100 detects, as a data category modification, that an existing data category no longer applies to the application code (due to a removal of one or more data processing activity components).

In some aspects, the application scanning service system 100 can detect that a change in a definition, functionality, and/or data type associated with a data processing activity component (present in the application code) to determine a data category modification. For instance, upon detecting a change in definition, functionality, and/or data type within a data processing activity component, the application scanning service system 100 can determine that a particular data category does not apply to the application code (or the data processing activity component). As a result, the application scanning service system 100 can remove and/or add of a data category for the data processing activity component (as a data category modification) based on the change in a definition, functionality, and/or data type associated with a data processing activity component (between application code versions).

In some cases, the application scanning service system 100 can determine a data processing activity component modification and/or data category modification based on a particular detector specification or detector group. In particular, upon determining that a particular detector specification or detector group matches to a data processing activity component, the application scanning service system 100 can determine an addition of a data processing activity component (in a new version of the application code). Furthermore, the application scanning service system 100 can determine that an addition of a data category associated with the detector specification or detector group due to the match. Moreover, in some instances, upon determining that a particular detector specification or detector group no longer matches to data processing activity component, the application scanning service system 100 can determine a removal of a data processing activity component and/or data category associated with the particular detector specification or detector group.

Although some aspects illustrate the application scanning service system 100 comparing analysis data objects to determine data processing activity component modifications and/or data category modifications, in some instances, the application scanning service system 100 can determine data processing activity component modifications and/or data category modifications based on a comparison of Issues sets between versions of an application code.

Furthermore, the application scanning service system 100 can utilize the data processing activity component modification(s) 1614 and/or the data category modification(s) 1616 to display a scan report for an application code that indicates changes of data processing activity components and/or data categories detected between application code versions. For instance, as illustrated in FIG. 16B, the application scanning service system 100 utilizes the data processing activity component modification(s) 1614 and/or the data category modification(s) 1616 to generate one or more user interface elements for display within, a graphical user interface 1620 (e.g., a scan report as described in FIG. 6) on a computing device 1618. As shown in FIG. 16B, the application scanning service system 100 provides, for display within the graphical user interface 1620, a scan report (in accordance with some aspects herein) that indicates metadata (e.g., a name, version, scan date) for an application code scanned by the application scanning service system 100.

Moreover, the application scanning service system 100 can utilize the determined data processing activity component modification(s) 1614 and/or the data category modification(s) 1616 to determine a total number of changes. Additionally, as shown in FIG. 16B, the application scanning service system 100 displays a counter element 1624 to display a number of changes from the data processing activity component modification(s) 1614 and/or the data category modification(s) 1616. For example, as shown in FIG. 16B, the application scanning service system 100 displays the counter element 1624 to indicate the total number of added data processing activity components in the scanned version of the application code in comparison to previous versions. Furthermore, as shown in FIG. 16B, the application scanning service system 100 displays a data category indicator 1626 with a change indicator to represent a change in a number of data processing activity components in a particular data category.

In one or more instances, the application scanning service system 100 can further display a number added data categories between application code scans based on the determined data processing activity component modification(s) 1614 and/or the data category modification(s) 1616. In some cases, the application scanning service system 100 can also display a number of removed data processing activity components and/or data categories based on the determined data processing activity component modification(s) 1614 and/or the data category modification(s) 1616.

As further shown in FIG. 16B, the application scanning service system 100 displays a legend 1622 to present a key or mapping for various types of changes detected between application code scans of multiple versions of an application code. For instance, as shown in the legend 1622 the application scanning service system 100 can utilize graphical color elements to indicate added data processing activity components, removed data processing activity components, and data processing activity components with no change.

Indeed, as shown in FIG. 16B, the application scanning service system 100 can apply visual indicators to the target functionality section corresponding to the data category indicator 1626 to distinguish among target functionalities found in the current scan result, the comparison scan result, or both. For instance, as shown in FIG. 16B, the application scanning service system 100 displays the “added” visual indicia (e.g., red highlight) for the target functionality 1630 found (for the first time) in the current scan result (e.g., last seen in the version 2.32.0). Furthermore, as shown in FIG. 16B, the application scanning service system 100 displays the “removed” visual indicia (e.g., green highlight and stricken-through text) for the target functionality 1632 found in the comparison scan result (e.g., found in a previous scan result, version 2.31.3, but not in the current scan result, version 2.32.0). In some aspects, the application scanning service system 100 can present the “added” or “removed” visual indicia for Issue elements having “true” values for the “added” field or the “removed” field.

Moreover, as shown in FIG. 16B, the application scanning service system 100 displays a target functionality 1628 with the “no change” visual indicia (e.g., no highlight and no stricken-through text) due to detecting the target functionality 1628 in the current scan result (e.g., version 2.32.0) and the comparison, previous scan result (e.g., 2.30.0). In addition, the application scanning service system 100 can indicate a last seen version indicator for the detected data processing activity components (e.g., the target functionalities). For example, as shown in FIG. 16B, the application scanning service system 100 displays a last seen version of 2.30.0 for the target functionality 1628.

Although some aspects herein illustrate utilizing strikethroughs and highlights to indicate changes in between application code version scans, the application scanning service system 100 can display various visual indicators to indicate the changes. For instance, the application scanning service system 100 can underline added data processing activity components and/or data categories. In some cases, the application scanning service system 100 can utilize symbols (e.g., exclamation points, arrows, plus or minus signs) to indicate a data processing activity component modification(s) and/or a data category modification(s).

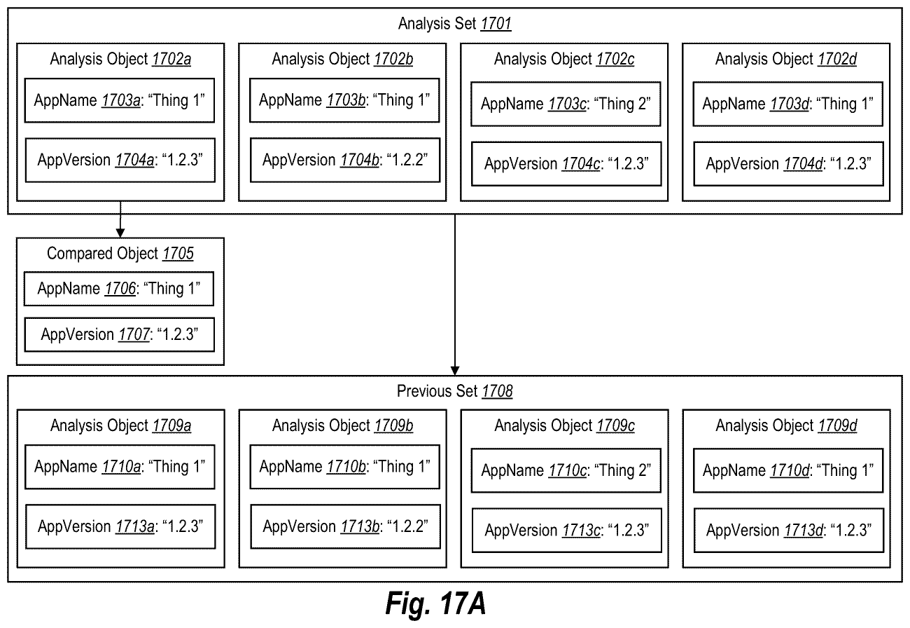

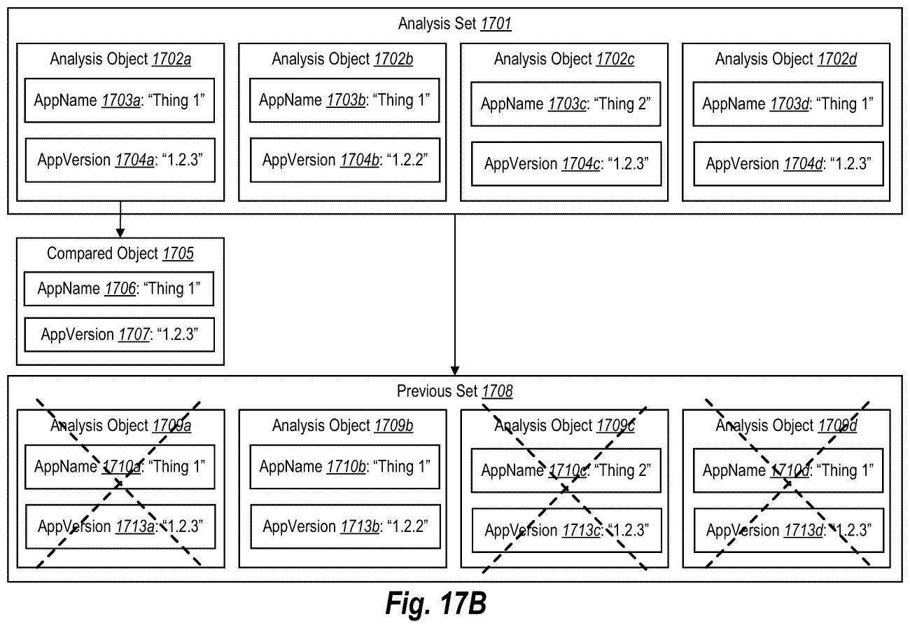

In some cases, the application scanning service system 100 utilizes the following exemplary set comparison process to determine data processing activity modifications and/or data category modifications. For instance, the application scanning service system 100 can, via the set comparison process, generate values for a lastSeen field, an “added” field, and/or a “removed” field of an analysis data object. Indeed, the application scanning service system 100 utilizing the set comparison process is described with respect to the examples and process depicted in FIGS. 17-20.

For example, FIG. 17A illustrates examples of an analysis set 1701 that includes analysis objects 1702a-d. In some implementations, the application scanning service system 100 can, via the set comparison process, generate a temporary “compared” object 1705 from an analysis object of interest (e.g., analysis object 1702a) and a temporary “previous” set 1708 from an analysis set containing multiple analysis objects (e.g., an array of all available analysis objects matching a certain criteria). In one or more instances, the application scanning service system 100 (e.g., via the application scanning service 103) further generates that “compared” object by converting the analysis object into a string, and parsing the string into a suitable data object (e.g., a JavaScript object). Thus, as illustrated in FIG. 17A, the “compared” object 1705 starts with dataset elements and values that are identical (or nearly identical) to the data elements and values of the analysis object (e.g., the analysis object 1702a).

Similarly, the application scanning service system 100 generates the “previous” set 1708 by converting the analysis set 1701 into a string, and parsing the string into a suitable data object (e.g., a JavaScript object) representing an array of analysis objects. Thus, as depicted in FIG. 17A, the “previous” set 1708 utilizes (or starts with) objects, data elements, and values that are identical (or nearly identical) to the objects, data elements, and values in the analysis set 1701.

Continuing with this example, the application scanning service system 100, in the set comparison process, can modify the “previous” set 1708 to remove invalid analysis objects, as shown by the modified data objects depicted in FIG. 17B. In this example, the application scanning service system 100 removes, from previous set 1708, an analysis object 1709c having a different application name than the “compared” object 1705 (e.g., appName 1710c has a value of “Thing 2” rather than the appName 1706 value of “Thing 1”). Moreover, as shown in FIGS. 17A and 17B, the application scanning service system 100 can remove, from the previous set 1708, analysis objects 1709a and 1709d having application version numbers greater than or equal to the “compared” object 1705 (e.g., while maintaining analysis object 1709b). For instance, appVersion 1713a has a value of “1.2.3” that is equal to appVersion 1707, and appVersion 1713d has a value of “1.2.3” that is equal to appVersion 1707.

In some implementations, if modifying the “previous” set 1708 results in an empty “previous” set 1708, the application scanning service system 100, via the set comparison process, can terminate and output the “compared” object 1705.

Furthermore, although the illustrations of the set comparison process with respect to FIGS. 17-20 refers to comparisons of an application version (e.g., AppVersion fields 1704a-d and 1713a-d), these comparisons can also be implemented using AppVersionCode values corresponding to AppVersion values.

In some implementations, the application scanning service system 100, in the set comparison process, can utilize a “key” variable to select a specific dataset within analysis data objects for comparison. For instance, as discussed above, an analysis data object can include an SDKs set, a URL dataset (prior to the compile process), a Results set (prior to the compile process), and/or an issues dataset (after the compile process). Moreover, an analysis data object can store these datasets as key-value pairs, such as values associated with a key name “sdks,” values associated with a key name “urls,” etc. The application scanning service system 100, in the set comparison process, can receive an input indicating which key name (i.e., the type of dataset) to utilize in a comparison process. For example, the application scanning service system 100, in the set comparison process, can set the “key” variable to the key name indicated by the input (e.g., “sdks,” “urls,” etc.).

In some implementations, the application scanning service system 100 can check for the existence of a dataset associated with the key (e.g., the key variable and/or key name). For instance, in response to receiving “results” as the key name, the application scanning service system 100 can check the analysis data object of interest (e.g., analysis object 1702a or “compared” object 1705) for the presence of a Results set. Additionally, in response to the Results set being absent, the application scanning service system 100, via the set comparison process, can terminate and return the “compared” object 1705. Indeed, a similar check can be utilized by the application scanning service system 100 for various key names, such as, but not limited to, “issues,” “urls,” and/or “sdks.”

In one or more instances, in response to receiving “issues” as the key name and the analysis data object of interest including an issues dataset, the application scanning service system 100, via set comparison process, can ensure that each analysis data object in the “previous” set 1708 includes an Issues set. To do so, the application scanning service system 100 can execute a compile process, such as the example described above with respect to FIGS. 6-15, on each analysis object in the “previous” set 1708.

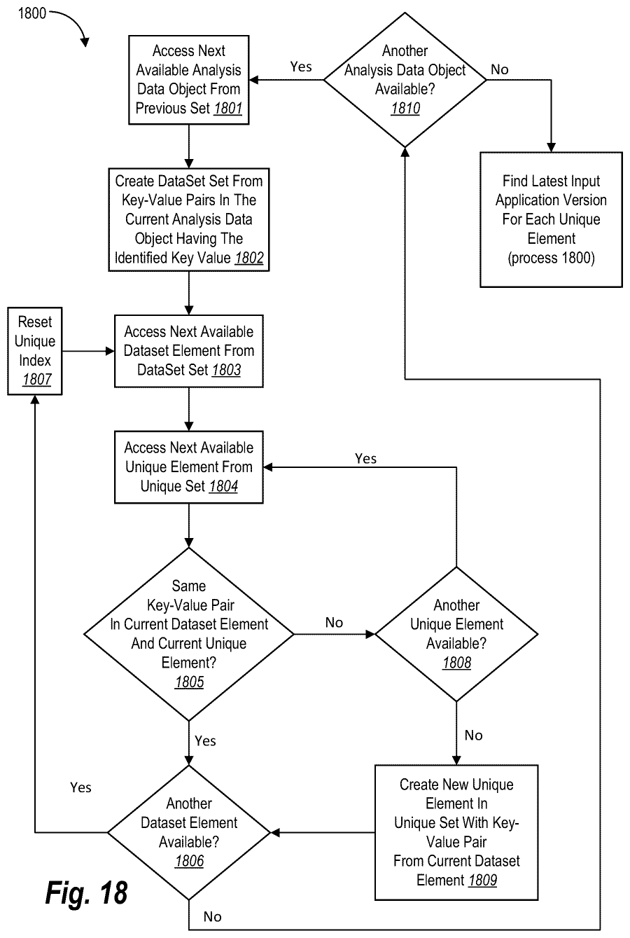

Additionally, FIG. 18 depicts an example of a process 1800 in which the application scanning service system 100 creates a Unique set containing unique items from the “previous” set 1708 by iterating through each element (i.e., analysis object) in the “previous” set 1708. For example, a Unique element in the Unique set can include a dataset of interest from the “previous” set 1708 and/or data regarding an application version for the dataset of interest (e.g., values of the appVersion and appVersionCode fields).

At block 1801, the application scanning service system 100, via the process 1800, retrieves or accesses a next available analysis object from the “previous” set (e.g., analysis object p). Furthermore, at block 1802, within an iteration involving the analysis object p, the application scanning service system 100 creates a (temporary) Dataset object (e.g., via a command: const data=previous[p][datasetName]) from key-value pairs in the current analysis object p that match the identified key value. Indeed, in one or more instances, the (temporary) Dataset object includes a set of Dataset elements. Furthermore, each Dataset element includes a key-value pair where the “key” is the key specified by the “key” variable. In an illustrative example, if the “key” variable is set to “sdks,” the application scanning service system 100 can create, at block 1802, a Dataset object having the SDKs set from the analysis object p. In this illustrative example, each element of the Dataset object includes a key-value pair where the key is “sdks” and the value is a specific identifier of an SDK (e.g., an SDK namespace).

In the iteration for the analysis object p, the application scanning service system 100, via the set comparison process, can iteratively search each element of the Unique set for each element of the temporary Dataset object. Furthermore, the application scanning service system 100 can utilize a control variable (e.g., a “found” variable) to control whether an iteration for Dataset element d causes modification of the Unique set (e.g., by setting “found” to “true” to skip logic for modifying the Unique set).

At block 1803, the application scanning service system 100 retrieves (or accesses) a next available Dataset element d of the (temporary) Dataset object. Moreover, at block 1804, the application scanning service system 100 retrieves or otherwise accesses a next available Unique element of the Unique set (e.g., Unique element u).

Furthermore, at block 1805, the application scanning service system 100 determines whether the same key-value pair is found in the current Dataset element and the current Unique element. Continuing with the SDK example above, the application scanning service system 100 can search the Unique set for the SDK key-value pair from the Dataset element d of the (temporary) Dataset object.

Indeed, if the application scanning service system 100 identifies the key-value pair is in the current Unique element (e.g., at the blocks 1804 and/or 1805), the application scanning service system 100 determines at block 1806 if another Dataset element is available. In some implementations, the application scanning service system 100 can cease iterating through the Unique set (e.g., via a “break” command) if the key-value pair is in the current Unique element u. Furthermore, upon determining that another dataset element is available, the application scanning service system 100 can reset an index for iterating through the Unique set at block 1807 and proceeds with an iteration involving Dataset element d+1 at block 1803.

In some instances, the application scanning service system 100 can fail to identify the key-value pair in the Unique set (at the blocks 1804 and/or 1805), the application scanning service system 100 can determine if another Unique element is available in the Unique set, as shown in block 1808. Indeed, if another Unique element is available, the application scanning service system 100, in the process 1800, can utilize Unique element u+1 from the Unique set (in the block 1804). Otherwise, if another Unique element is not available, the application scanning service system 100 can create a new Unique element of the Unique set, as shown at block 1809. In the SDK example from above, the Unique element can include a data element populated with the SDK key-value pair from element d of the (temporary) Dataset object, a version field populated with the version field value from the analysis object p, and a vcode field populated with the appVersionCode field value from the analysis object p. Thus, the Unique element can indicate that a particular SDK was found in a particular version of the input application.

After completing all iterations for a (temporary) Dataset object (e.g., completes the iteration in which d equals the length of the (temporary) Dataset object), the application scanning service system 100, in the set comparison process, can determine if another analysis object is available, as shown in block 1810. If another analysis object is available, the application scanning service system 100, in the process 1800, can proceed to the block 1801 and perform a new iteration using an analysis object p+1. Otherwise, when process 1800 completes all iterations for the “previous” set 1708 (e.g., completes the iteration in which p equals the length of the “previous” set 1708), the Unique set has been built. In some cases, the Unique set includes a set of unique datasets of interest. In the SDK example above, the unique datasets of interest can include a set of SDKs (e.g., SDK key-value pairs) in which each Unique element includes a different set of values for the Version and/or Vcode fields.

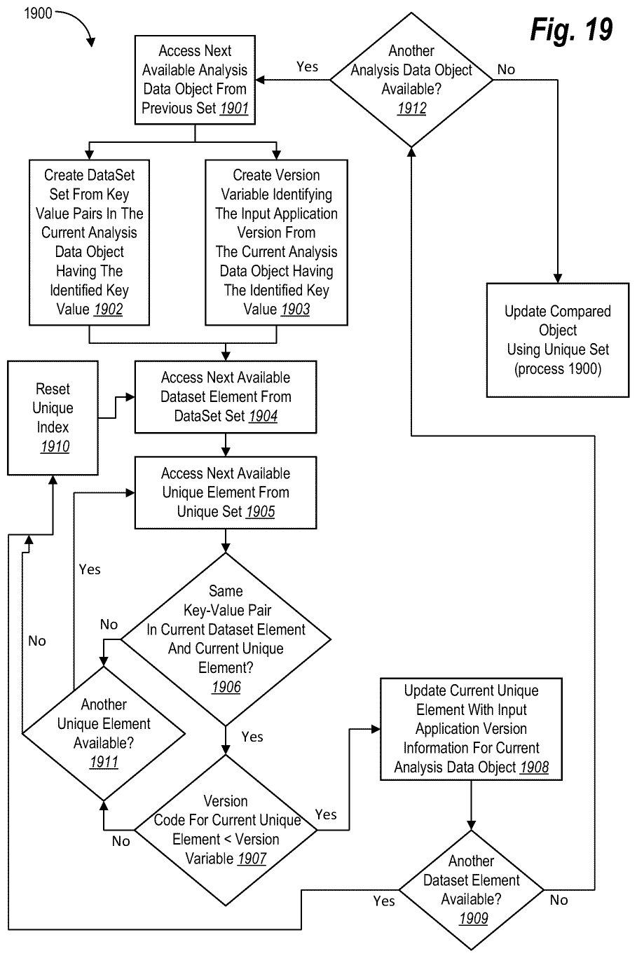

In addition, FIG. 19 depicts an example of a process 1900 for modifying the Unique set to indicate, in each Unique element, a latest version of the input application in which the data element from the Unique element was found. For example, at block 1801, the application scanning service system 100, in the process 1900, can retrieve or access an available analysis data object from the “previous” set (e.g., analysis object p). Moreover, at the block 1902 (within an iteration involving the analysis object p), the application scanning service system 100 can create a (temporary) Dataset object (e.g., via a command: const data=previous[p][datasetName]) from key-value pairs in the current analysis object p that match the identified key value. In some cases, the application scanning service system 100 can do so in a manner similar to that described above with respect to block 1801 of the process 1800.

At block 1903, the application scanning service system 100 creates a (temporary) Dataset object and a version variable (e.g., vcode). In particular, at the block 1903, the application scanning service system 100 creates a version variable identifying the input application version from the current analysis data object having the identified key value. In some cases, the application scanning service system 100 initially sets version variable to a value identifying the application version, such as the value of the appVersioncode field from the analysis object p.

Moreover, at block 1904, the application scanning service system 100 can retrieve (or access) a next available Dataset element d of the (temporary) Dataset object. Furthermore, at block 1905, the application scanning service system 100 retrieves (or accesses) a next available Unique element of the Unique set (e.g., Unique element u).

At block 1906, the application scanning service system 100 determines whether the same key-value pair is found in the current Dataset element and the current Unique element. Indeed, the application scanning service system 100 can determine the matching key-value pair in a manner similar to block 1805 (described above).

For example, upon determining that the same key-value pair is found in the current Dataset element and the current Unique element, the application scanning service system 100, at block 1907, determines whether a version for the Unique element is less than the version variable. For instance, the application scanning service system 100 can determine if the Unique element u has a vcode field value less than the version variable. Indeed, if a negative determination results from either of blocks 1906 or 1907, the process 1900 proceeds to block 1911. Furthermore, if the application scanning service system 100 determines, at block 1911, that another Unique element is available, the process 1900 proceeds to block 1905 and performs another iteration using Unique element u+1. Otherwise, the application scanning service system 100, in the process 1900, resets an index for iterating through the Unique set at block 1910 and proceeds to block 1904, where the application scanning service system 100 initiates a new iteration using dataset element d+1 from the (temporary) Dataset object.

Furthermore, if blocks 1906 and 1907 result in positive determinations, the application scanning service system 100, at the block 1908, updates the current Unique element with input application version information for the current analysis data object p. For instance, the application scanning service system 100 can set the vcode field of the Unique element u to the version variable value and can set the version field Unique element u to the value of the appVersion field in the current analysis data object p.

At block 1909, the application scanning service system 100 determines if another Dataset element is available. Indeed, if another Dataset element is available, the application scanning service system 100, in the process 1900, resets an index for iterating through the Unique set at block 1910 and proceeds to block 1904, where the application scanning service system 100 initiates a new iteration using dataset element d+1 from the (temporary) Dataset object.

In the SDK example above, the application scanning service system 100 can identify an SDK in the Unique set that exists in both the input application version for the analysis object p and a different input application version for another analysis object in the “previous” set 1708. If the different input application version is lower (e.g., an earlier application version), the application scanning service system 100 can update the Unique element for that SDK in the Unique set to the input application version for the analysis object p (e.g., the latest application version yet encountered when iterating through the “previous” set 1708).

At block 1912, the application scanning service system 100, in the process 1900, can determine if another Analysis data object from the “previous” set 1708 is available. If another analysis data object is available, the application scanning service system 100 can initiate a new iteration using analysis object p+1 (in the block 1901). Otherwise, when all iterations for the “previous” set 1708 are complete, the application scanning service system 100 can update the compared object using the unique set. Indeed, when all iterations for the “previous” set 1708 are complete, the unique set can include a de-duplicated set of key-value pairs and/or, for each key-value pair, a latest application version number for the key-value pair across all analysis objects (i.e., scan of input application versions) in the “previous” dataset.

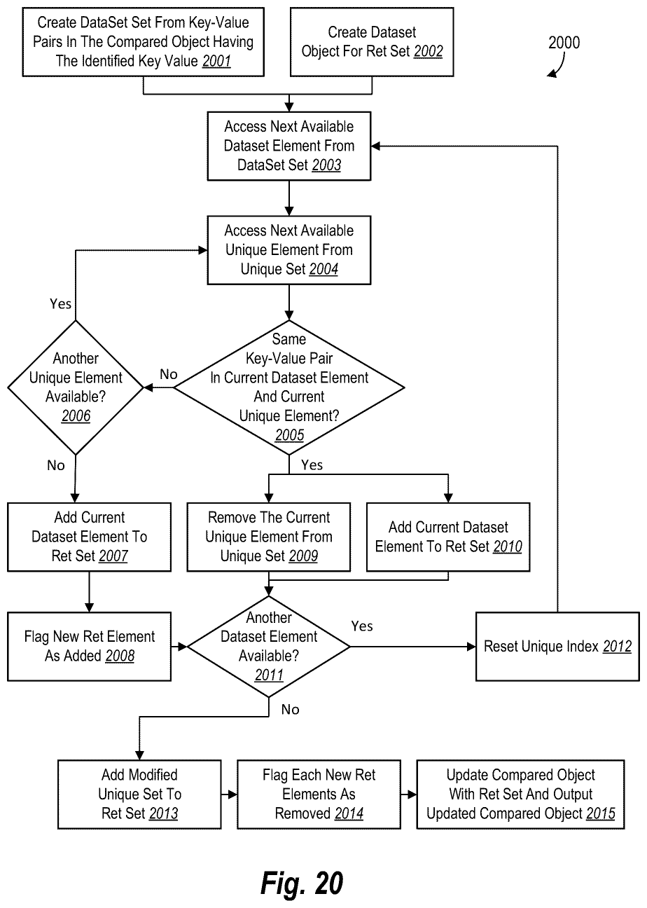

Furthermore, the application scanning service system 100 can utilize the modified Unique set outputted by the process 1900 to modify the “compared” object. For example, FIG. 20 depicts an example of a process 2000 for modifying a “compared” analysis object.

For example, at block 2001, the application scanning service system 100, in the process 2000, creates a (temporary) Dataset set (or object) from key-value pairs in the “compared” object that match the identified key value. For example, the application scanning service system 100 can create a (temporary) Dataset object in a manner similar to that described above with respect to block 1802 of the process 1800.

Additionally, at block 2002, the application scanning service system 100, in the process 2000, can create a dataset object for a Ret set. Indeed, the application scanning service system 100 can modify the Ret set, in the process 2000, to build a set of key-value pairs for the key of interest (e.g., all SDKs) that are found in the version of the input application utilized to generate the “compared” object 1705 and/or a different (e.g., earlier) version of the input application.

In addition, in the process 2000, the application scanning service system 100 can identify one or more added and retained detections. Indeed, the application scanning service system 100, as part of the set comparison process, can modify the Unique set to remove one or more Unique elements having a key-value pair that is also present in the Dataset object from “compared” object 1705. For instance, at block 2003, the application scanning service system 100 retrieves or otherwise accesses a next available Dataset element d of the (temporary) Dataset object. In addition, at block 2004, the application scanning service system 100 retrieves (or accesses) a next available Unique element from the Unique set (e.g., Unique element u).

Moreover, at block 2005, the application scanning service system 100 determines whether the same key-value pair is found in the current Dataset element and the current Unique element. In some aspects, the application scanning service system 100 determines if the key-value pair matches in a manner similar to block 1805 described above. Furthermore, if the key-value pairs match at block 2005, the application scanning service system 100 removes the current Unique element u from the Unique set, as shown at block 2009. Also, the application scanning service system 100 adds the current Dataset element d to the Ret dataset, as shown at block 2010. For example, the application scanning service system 100 can update the Ret set to include a Ret element having copy of the key-value pair from element d. Moreover, the application scanning service system 100 can set a “lastSeen” field in the Ret element to the value of appVersion value from the “compared” object 1705.

The application scanning service system 100 can also determine, at block 2011, if another Dataset element is available. If another Dataset element is available, the application scanning service system 100, in the process 2000, resets an index for iterating through the Unique set at block 2012 and proceeds with an iteration involving Dataset element d+1 at block 2003.

Additionally, if the key-value pairs do not match at block 2005, the application scanning service system 100 can determine if another Unique element is available, as shown at block 2006. If another Unique element is available, the application scanning service system 100 can proceed to block 2004 and initiate a new iteration utilizing a Unique element u+1 from the Unique set.

Otherwise, after iterations for all elements of the Unique set have been completed (e.g., a negative determination at block 2006), the application scanning service system 100 obtains a modified Unique set that can include key-value pairs found in input application versions other than the application version corresponding to the “compared” object 1705. Moreover, at block 2007, the application scanning service system 100 adds the current Dataset element d to the Ret dataset in a manner similar to that described above for block 2010. Furthermore, at block 2008, the application scanning service system 100 flags the new Ret element from block 2007 as “added.” For instance, if a control variable for the iteration involving Dataset element d (e.g., a “found” variable set during the iterations through the Unique set) indicates that the key-value pair from the Dataset element d was not found in the Unique set, the application scanning service system 100 can set an “added” field of the Ret element to “true.” In the example involving SDKs, if an SDK was first added to the input application in a current version corresponding to the “compared” object 1705, the application scanning service system 100 can set the “added” field to “true” because a key-value pair identifying the SDK was not present in the Unique set. Otherwise, the application scanning service system 100 can leave the “added” field of the “ret” element with a default “false” value or sets the “added” field to a “false” value. In addition, as shown in FIG. 20, the process 2000 proceeds from block 2008 to block 2011.

In FIG. 20, by iterating through the entire Dataset set, the application scanning service system 100 results in (or obtains) a modified Unique set having detections that do not exist in an input application version corresponding to the “compare” object. The process 2000 can further involve adding the modified Unique set to the Ret dataset, as shown at block 2013. For instance, the application scanning service system 100 can iterate through each element of the modified Unique set.

Furthermore, in each iteration involving element u of the modified Unique set, the application scanning service system 100 can update the “ret” set to include a “ret” element having copy of the key-value pair from Unique element u. The application scanning service system 100 can set the new Ret element's “lastSeen” field to the application version number in the “lastSeen” field of element u. The application scanning service system 100 can also set a “removed” field of the new Ret element to “true,” as shown block 2014. For instance, if an SDK was not present in a current input application version corresponding to the “compared” object 1705, the application scanning service system 100 can set the “removed” field to “true” because a key-value pair identifying the SDK was present in the Unique set but not the “compared” object 1705. Otherwise, the application scanning service system 100 can leave the “removed” field of the “ret” element with a default “false” value or can set the “removed” field to a “false” value.

Moreover, at block 2015, the application scanning service system 100 updates the “compared” object 1705 with the Ret set and outputs the compared object 1705. For example, the application scanning service system 100 can replace dataset elements having the key value with the “ret” dataset. In the illustrative example involving SDKs, the application scanning service system 100 can replace an array including key-value pairs with an “sdks” with an array having a de-duplicated set of SDKs, the latest application version in which the SDKs are found (e.g., the “lastSeen” field values), and information on whether the SDKs were added to or removed (e.g., the “added” and “removed” field values) from the input application in the version corresponding to the “compared” object 1705. Subsequently, the application scanning service system 100 can output the updated “compared” object 1705.

### Example of Input Application Modification Based on Scan Results

In some aspects, the application scanning service system 100 can enable functionalities within software development tools for an application code based on a generate software profiled (in accordance with some aspects herein). For example, the application scanning service system 100 can utilize information from a (generated) software profile, such as information regarding caller class/methods and target functionalities, location data, and/or data categories to enable a software development tool (and/or user of the software development tool) to more quickly and accurately locate which portions of the input application (e.g., which portions of the input application source code) include data processing activity components and/or data in certain categories. Indeed, in some cases, the application scanning service system 100 can enable a software development tool to accurately locate portions of code that contain particular data processing activity components and/or data categories to enable the reduction or modification of the extent to which the input application collects or processes certain data.

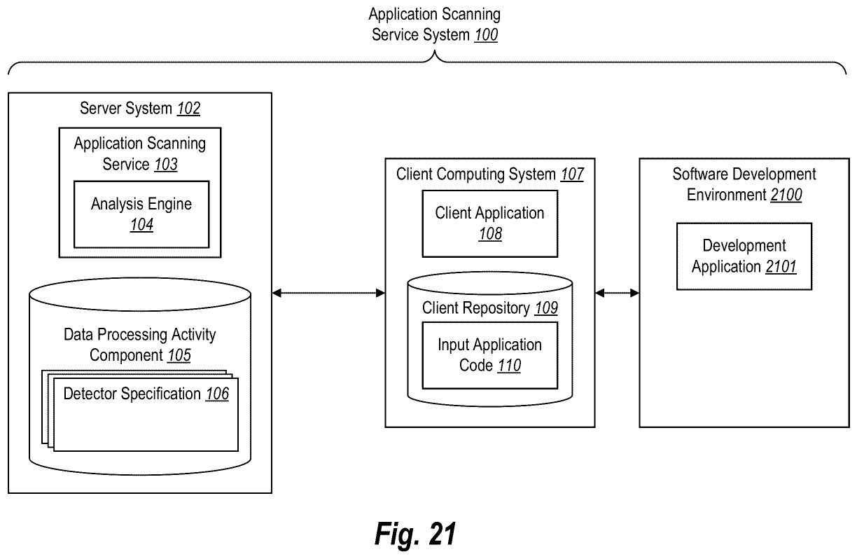

For instance, FIG. 21 illustrates an example of a software development environment 2100 that can be included in or used in combination with one or more of the server system 102 and the client computing system 107 (as described in FIG. 1). In FIG. 21, a development application 2101 of the software development environment 2100 can be executed on a computing system, such as a server system 102, the client computing system 107, and/or a separate computing system.

Indeed, the development application 2101 can provide one or more features for developing computer-executable program code, such as, for example, a source code editor, a compiler, an assembler, etc. Moreover, the development application 2101 can be utilized to generate or modify code of an input application (e.g., source code, assembly language, etc.). In some aspects, the development application 2101 can be used to create, modify, or otherwise access source code in a high-level programming language.

Furthermore, the development application 2101 can execute one or more compiler modules and thereby compile the source code into assembly language. In additional or alternative aspects, the development application 2101 can be utilized to create, modify, or otherwise access assembly language without using source code in a high-level programming language. In some aspects, the development application 2101 can execute one or more assembler modules and thereby assemble assembly language into object code, binary code, and/or other machine code executable by processing hardware.

In some aspects, a development application 2101 can communicate with (or otherwise be used in combination with) the application scanning service 103 to modify input application code 110. For instance, a software profile generated for the input application code 110 by the application scanning service 103 (e.g., as described above) can indicate that the input application code 110 includes one or more data processing activity components and/or data categories that may be modified or inspected. In an illustrative example, such a software profile can indicate that the input application code 110 collects or otherwise processes data in particular a data category. Indeed, such processing of data in this data category may be impermissible or undesirable (e.g., in a software deployment platform and/or by compliance requirements). In such cases, the application scanning service system 100 can, via the generated software profile, enable the identification of how and/or where the input application code 110 collects or otherwise processes such data (e.g., by identifying a target functionality and its associated caller class/method pair in the application code).

Furthermore, the application scanning service system 100 (or the software development environment 2100) can enable modification of the input application code 110 in the development application 2101 (e.g., in response to appropriate user inputs) to reduce or modify the identified collection or processing of data in the data category (from the software profile).

In some aspects, the software profile can be provided to the development application 2101 directly by the application scanning service 103, via an integration, so that target functionalities can be identified in the input application code 110 for further examination and modification. In additional or alternative aspects, the software profile can be provided via an application separate from the development application 2101, and a user of the development application 2101 can identify the target functionalities from the software profile for further examination and modification via the development application.

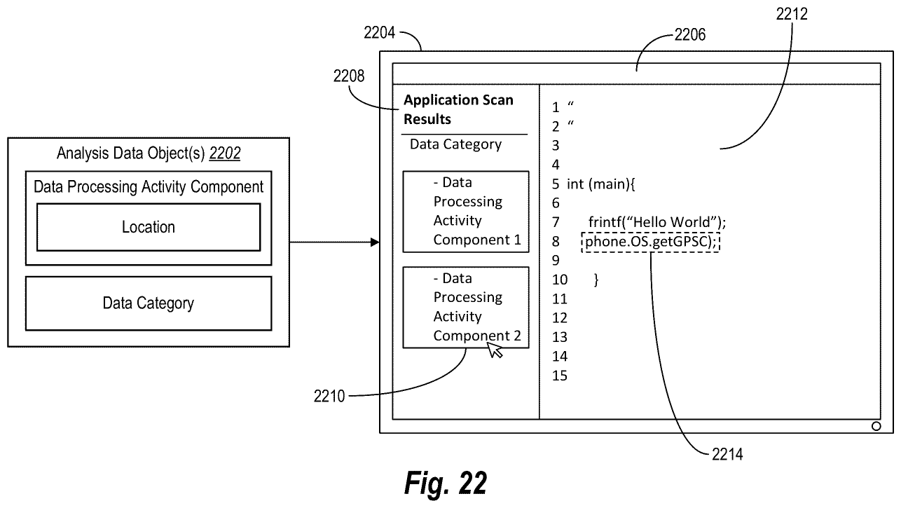

For example, FIG. 22 illustrates the application scanning service system 100 enabling a development application 2101 to identify target functionalities from the software profile for further examination and modification via a development application. As shown in FIG. 22, the application scanning service system 100 provides an analysis data object(s) 2202 including data processing activity components and corresponding location data (with data categories) to a development application on a computing device 2204. Indeed, as shown in FIG. 22, the application scanning service system 100 enables a graphical user interface 2206 of the development application on the computing device 2204 to display application scan results 2208 (from the analysis data object(s) 2202).

Upon receiving a user selection of selectable element 2210 for a data processing activity component (e.g., the “data processing activity component 2”), the application scanning service system 100 enables the development application to utilize the location data from the analysis data object(s) 2202 to display an indicator 2214 within a code development environment 2212. Indeed, as shown in FIG. 22, the application scanning service system 100 can enable the development application to utilize the location data to navigate to (and flag) a portion of the application code that corresponds to the selected data processing activity component. In one or more instances, the application scanning service system 100 can enable the code development environment 2212 to modify the application code (based on user interactions) to reduce and/or modify the identified collection or processing of data in the data category (as described above).

In one or more cases, the application scanning service system 100 can similarly enable development application to display selectable data categories with corresponding location data to display portions of codes (or indicators within the portions of code) to highlight, flag, or indicate data processing activity components that correspond to the data category. As an example, upon receiving a user selection of a data category, the application scanning service system 100 can enable the development application to identify one or more data processing activity components (via the analysis data object data) and corresponding locations in the application code. Furthermore, the application scanning service system 100 can enable the development application to navigate to (and indicate) the portions of application code that include the one or more data processing activity components for the data category. In some cases, the development application can include an option to cycle through the one or more data processing activity components for the data category to navigate to (and indicate) the portions of application code that include the one or more data processing activity components.

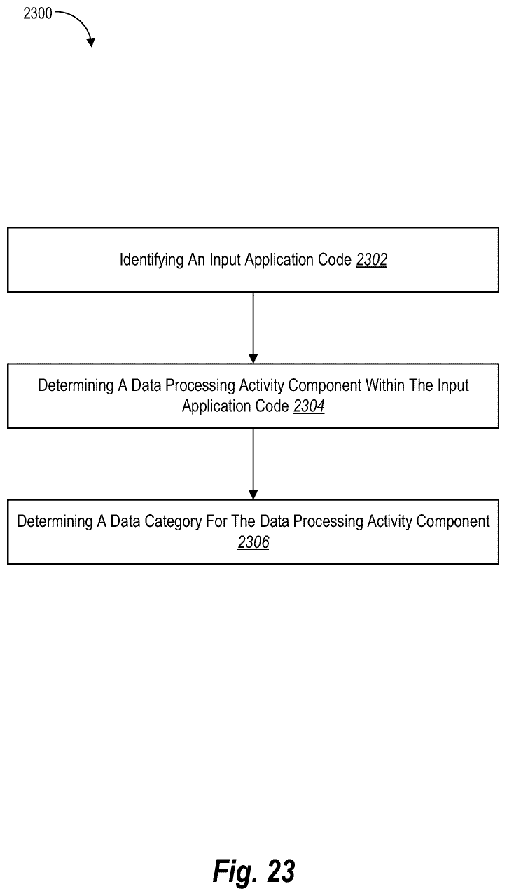

FIGS. 1-22, the corresponding text, and the examples provide a number of different methods, systems, devices, and non-transitory computer-readable media of the application scanning service system 100. In addition to the foregoing, one or more aspects can also be described in terms of flowcharts comprising acts for accomplishing a particular result, as shown in FIGS. 23-25. The acts shown in FIGS. 23-25 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIGS. 23-25. In some aspects, a system can be configured to perform the acts of FIGS. 23-25. Alternatively, the acts of FIGS. 23-25 can be performed as part of a computer implemented method.

For example, FIG. 23 illustrates a flowchart of a series of acts 2300 for scanning an application code to determine data categories for the application code in accordance with some aspects. While FIG. 23 illustrates acts according to one aspect, alternative aspects may omit, add to, reorder, and/or modify any of the acts shown in FIG. 23.

As shown in FIG. 23, the series of acts 2300 include an act 2302 of identifying an input application code, an act 2304 of determining a data processing activity component within the input application code, and an act 2306 of determining a data category for the data processing activity component.

In one or more aspects, the act 2302 can include identifying an input application code, the act 2304 can include, based on a scan of the input application code, determining one or more data processing activity components within the input application code, and the act 2306 can include determining data categories for the one or more data processing activity components. For example, the data categories can include data types or data processing purpose type corresponding to the one or more data processing activity components.

Furthermore, in some cases, the series of acts 2300 can include determining the one or more data processing activity components by identifying a data processing component reference within the input application code, wherein a data processing activity component comprises a software development kit (SDK) component, an application programming interface (API) component, or a function call component.

Additionally, the series of acts 2300 can include determining the one or more data processing activity components by matching a namespace from the input application code to a detector specification entry, within a detector specification, indicating pairings between one or more namespaces and one or more data processing components. For example, the detector specification entry can include at least one of the namespace, a scanning identifier for the namespace, a data processing description for the namespace, a data type, and/or a functionality type.

Moreover, the series of acts 2300 can include determining the data categories for the one or more data processing activity components by identifying a data type corresponding to a data processing activity component from the one or more data processing activity components and utilizing the data type to assign the data processing activity component with a data category. For instance, a data type can include location data, cookie data, camera data, computing device data, demographic data, hit-level data, device usage data, and/or personal identifiable information data. In some cases, the series of acts 2300 can include determining data categories for the one or more data processing activity components by determining a first data category associated with a first set of data processing activity components from the one or more data processing activity components grouped by a first data type and/or determining a second data category associated with a second set of data processing activity components from the one or more data processing activity components grouped by a second data type.

In addition, the series of acts 2300 can include determining the data categories for the one or more data processing activity components by identifying a data processing purpose type corresponding to a data processing activity component from the one or more data processing activity components. In addition, the series of acts 2300 can include determining the data categories for the one or more data processing activity components by utilizing the data processing purpose type to assign the data processing activity component with a data category. For instance, the data processing purpose type can include utilization for application function, analytics, digital advertisement targeting, data aggregation, and/or debugging.

Additionally, the series of acts 2300 can include determining the data categories for the one or more data processing activity components by determining a source for a data processing activity component. For example, the source can include an owner entity or a developer for the data processing activity component.

Moreover, the series of acts 2300 can include determining the one or more data processing activity components from a call graph generated from the input application code. For instance, the call graph can include nodes indicating name spaces, class names, or method names within the input application code. Additionally, the series of acts 2300 can include utilizing the call graph to assign a data processing activity component or a data category to a portion of the input application code.

In addition, the series of acts 2300 can include generating a software profile for the input application code by assigning the data categories for the one or more data processing activity components to a first version of the input application code, determining, from a second version of the input application code, additional data categories for additional data processing activity components, and/or assigning the additional data categories for the additional data processing activity components to the second version of the input application code.

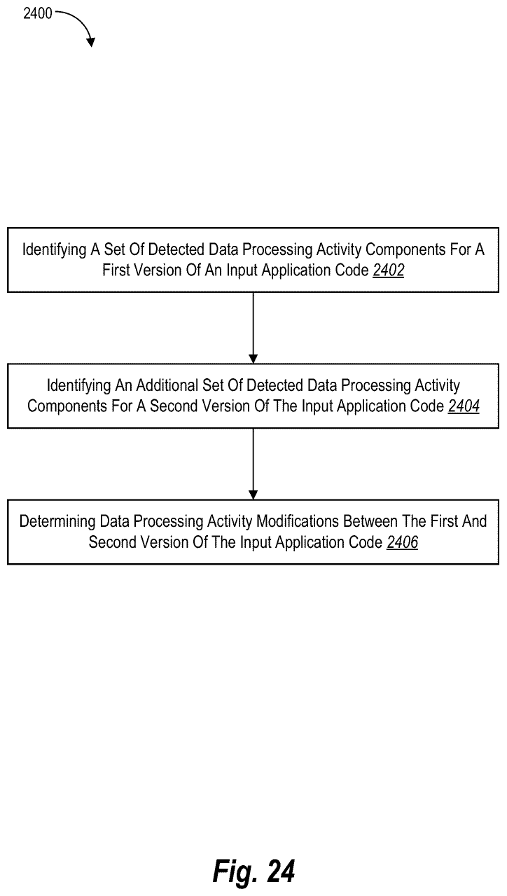

Furthermore, FIG. 24 illustrates a flowchart of a series of acts 2400 for determining data processing activity and/or data category modifications between scanned versions of an application code in accordance with some aspects. While FIG. 24 illustrates acts according to one aspect, alternative aspects may omit, add to, reorder, and/or modify any of the acts shown in FIG. 24.

As shown in FIG. 24, the series of acts 2400 include an act 2402 of identifying a set of detected data processing activity components for a first version of an input application code, an act 2404 of identifying an additional set of detected data processing activity components for a second version of the input application code, and an act 2406 of determining data processing activity modifications between the first and second version of the input application code.

In one or more instances, the act 2402 can include identifying a set of detected data processing activity components within a first version of an input application code, the act 2404 can include scanning a second version of the input application code to identify an additional set of detected data processing activity components within the second version of the input application code, and the act 2406 can include determining data processing activity component modifications between the first version of the input application code and the second version of the input application code based on the set of detected data processing activity components and the additional set of detected data processing activity components. For instance, the set of detected data processing activity components can include software development kit (SDK) components, application programming interface (API) components, and/or function call components.

Furthermore, the series of acts 2400 can include determining the data processing activity component modifications between the first version of the input application code and the second version of the input application code by identifying an addition or removal of a data processing activity component between the set of detected data processing activity components and the additional set of detected data processing activity components.

Additionally, the series of acts 2400 can include identifying a set of data categories for the set of detected data processing activity components and/or identifying an additional set of data categories for the additional set of detected data processing activity components. Moreover, the series of acts 2400 can include determining data category modifications between the first version of the input application code and the second version of the input application code based on the set of data categories and the additional set of data categories. For instance, a data category can include a data type or data processing purpose type corresponding to one or more data processing components from the set of detected data processing activity components.

Moreover, the series of acts 2400 can include determining the data category modifications between the first version of the input application code and the second version of the input application code by identifying an addition or removal of a data category between the set of data categories and the additional set of data categories. In some cases, the series of acts 2400 can include determining a number of added data processing activity components from the data processing activity component modifications.

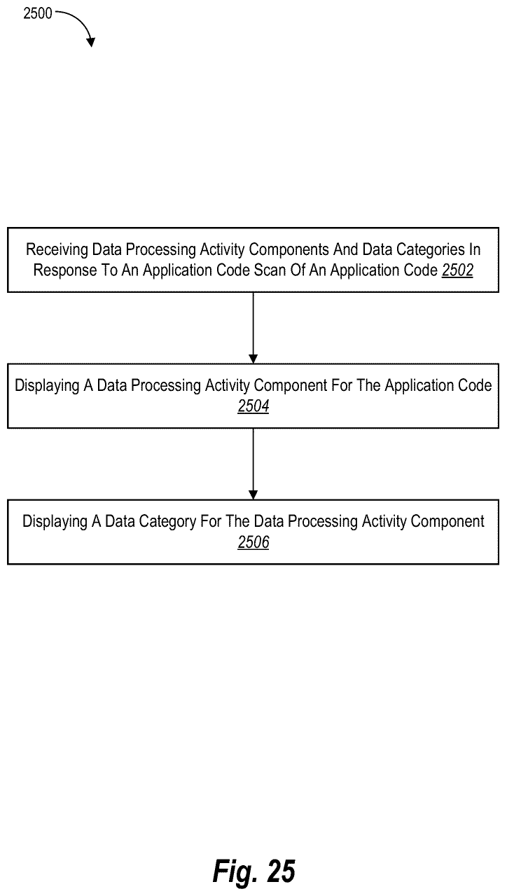

Additionally, FIG. 25 illustrates a flowchart of a series of acts 2500 for displaying scan results of determined data categories in an application code in accordance with some aspects. While FIG. 25 illustrates acts according to one aspect, alternative aspects may omit, add to, reorder, and/or modify any of the acts shown in FIG. 25.

For instance, as shown in FIG. 25, the series of acts 2500 include an act 2502 of receiving data processing activity components and data categories in response to an application code scan of an application code, an act 2504 of displaying a data processing activity component for the application code, and an act 2506 of displaying a data category for the data processing activity component.

In one or more instances, the act 2502 can include receiving, in response to an application code scan, a set of data processing activity components identified within an application code and data categories for the set of data processing activity components, the act 2504 can include, based on the set of data processing activity components, providing, for display within a graphical user interface, a data processing activity component from the set of data processing activity components, and the act 2506 can include, based on the data categories, providing, for display within the graphical user interface, a data category indicating one or more data types or one or more data processing purpose types represented in the set of data processing activity components.

Moreover, the series of acts 2500 can include providing, for display within the graphical user interface, the data processing activity component by displaying software development kit (SDK) components, application programming interface (API) components, or function call components present within the application code. In some cases, the series of acts 2500 can include providing, for display within the graphical user interface, the data processing activity component by displaying a number of software development kit (SDK) components or application programming interface (API) components present within the application code.

In addition, the series of acts 2500 can include providing, for display within the graphical user interface, the data category indicating the one or more data types by displaying one or more of location data, cookie data, camera data, computing device data, demographic data, hit-level data, device usage data, and/or personal identifiable information data processed within the application code. Furthermore, the series of acts 2500 can include providing, for display within the graphical user interface, the data category indicating the one or more data processing purpose types by displaying an application function category, an analytics category, a digital advertisement targeting category, a data aggregation category, or a debugging category. In some cases, the series of acts 2500 include providing, for display within the graphical user interface, one or more data processing activity components from the set of data processing activity components grouped in relation to the data category.

Moreover, the series of acts 2500 can include providing, for display within the graphical user interface, the data category by displaying a source for a data processing activity component from the set of data processing activity components. For example, the source can include an owner entity or a developer for the data processing activity component.

Additionally, the series of acts 2500 can include receiving, within the graphical user interface, a user interaction with a selectable element for the displayed data category. Moreover, the series of acts 2500 can include, based on the user interaction with the selectable element, displaying one or more data processing activity components, from the application code, that correspond to the displayed data category.

Furthermore, the series of acts 2500 can include receiving data processing activity component modifications and/or data category modifications detected between the application code and an updated version of the application code. In addition, the series of acts 2500 can include providing, for display within the graphical user interface, the data processing activity component modifications and/or the data category modifications. For example, the data processing activity component modifications can include an addition and/or removal of one or more data processing activity components. Moreover, the data category modifications can include an addition and/or removal of one or more data categories.

Additionally, the series of acts 2500 can include providing, for display within the graphical user interface, a flagging element associated to a display of the data processing activity component to indicate the data processing activity component modifications or to a display of the data category to indicate the data category modifications. In some aspects, the series of acts 2500 can include providing, for display within the graphical user interface, the data processing activity component modifications by providing, for display within the graphical user interface, an added data processing activity component with a first graphical indicator and/or providing, for display within the graphical user interface, a removed data processing activity component with a second graphical indicator. Additionally, the series of acts 2500 can include providing, for display within the graphical user interface, an indication of a version of the application code in which the data processing activity component was detected. In some instances, the series of acts 2500 can include providing, for display within the graphical user interface, a number of added data processing activity components based on the data processing activity component modifications.

Additionally, the series of acts 2500 can include providing, for display within a development application graphical user interface presenting the application code, an indicator locating the data processing activity component within the application code. In some cases, the series of acts 2500 can include providing, for display within a development application graphical user interface presenting the application code, an indicator flagging a portion of code from the application code as part of the data category.

Moreover, in some aspects, the series of acts 2300 can include one or more of the acts from the series of acts 2400 and/or one or more of the acts from the series of acts 2500. Furthermore, the series of acts 2400 can include one or more of the acts from the series of acts 2300 and/or one or more of the acts from the series of acts 2500. Additionally, the series of acts 2500 can include one or more of the acts from the series of acts 2300 and/or one or more of the acts from the series of acts 2400.

### Computing System Example for Implementing Various Implementations

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 26 depicts an example of a computing system 2600 that can be used for performing the operations described herein. One or more devices depicted in FIG. 1 (e.g., a server system 102, a client computing system 107, a software development environment 2100, etc.) can be implemented using the computing system 2600 or a suitable variation.

The computing system 2600 can include processing hardware 2602 that executes program code 2605 (e.g., an analysis engine or other component of an application scanning service). The computing system 2600 can also include a memory device 2604 that stores one or more sets of program data 2607 (e.g., a data processing activity component library 105, a client repository 109 with input application code 110, etc.) computed or used by operations in the program code 2605. The computing system 2600 can also include and one or more presentation devices 2612 and one or more input devices 2614. For illustrative purposes, FIG. 26 depicts a single computing system on which the program code 2605 is executed, the program data 2607 is stored, and the input devices 2614 and presentation device 2612 are present. But various applications, datasets, and devices described can be stored or included across different computing systems having devices similar to those depicted in FIG. 26.

The depicted example of a computing system 2600 includes processing hardware 2602 communicatively coupled to one or more memory devices 2604. The processing hardware 2602 executes computer-executable program instructions stored in a memory device 2604, accesses information stored in the memory device 2604, or both. Examples of the processing hardware 2602 include a microprocessor, an application-specific integrated circuit (“ASIC”), a field-programmable gate array (“FPGA”), or any other suitable processing device. The processing hardware 2602 can include any number of processing devices, including a single processing device.

The memory device 2604 includes any suitable non-transitory computer-readable medium for storing data, program instructions, or both. A computer-readable medium can include any electronic, optical, magnetic, or other storage device capable of providing a processor with computer-readable instructions or other program code 2605. Non-limiting examples of a computer-readable medium include a magnetic disk, a memory chip, a ROM, a RAM, an ASIC, optical storage, magnetic tape or other magnetic storage, or any other medium from which a processing device can read instructions. The program code 2605 may include processor-specific instructions generated by a compiler or an interpreter from code written in any suitable computer-programming language, including, for example, C, C++, C#, Visual Basic, Java, Python, Perl, JavaScript, and ActionScript.

The computing system 2600 may also include a number of external or internal devices, such as an input device 2614, a presentation device 2612, or other input or output devices. For example, the computing system 2600 is shown with one or more input/output (“I/O”) interfaces 2608. An I/O interface 2608 can receive input from input devices or provide output to output devices. One or more buses 2606 are also included in the computing system 2600. The bus 2606 communicatively couples one or more components of a respective one of the computing system 2600.

The computing system 2600 executes program code 2605 that configures the processing hardware 2602 to perform one or more of the operations described herein. The program code 2605 includes, for example, the one or more applications described herein with respect to FIGS. 1-25 (e.g., the application scanning service, the analysis engine, the development application, the client application, etc.). The program code 2605 may be resident in the memory device 2604 or any suitable computer-readable medium and may be executed by the processing hardware 2602 or any other suitable processor. The program code 2605 uses or generates program data 2607.

In some implementations, the computing system 2600 also includes a network interface device 2610. The network interface device 2610 includes any device or group of devices suitable for establishing a wired or wireless data connection to one or more data networks. Non-limiting examples of the network interface device 2610 include an Ethernet network adapter, a modem, and/or the like. The computing system 2600 can communicate with one or more other computing devices via a data network using the network interface device 2610.

A presentation device 2612 can include any device or group of devices suitable for providing visual, auditory, or other suitable sensory output. Non-limiting examples of the presentation device 2612 include a touchscreen, a monitor, a separate mobile computing device, etc. An input device 2614 can include any device or group of devices suitable for receiving visual, auditory, or other suitable input that controls or affects the operations of the processing hardware 2602. Non-limiting examples of the input device 2614 include a recording device, a touchscreen, a mouse, a keyboard, a microphone, a video camera, a separate mobile computing device, etc.

Although FIG. 26 depicts the input device 2614 and the presentation device 2612 as being local to the computing device that executes the program code 2605, other implementations are possible. For instance, in some implementations, one or more of the input devices 2614 and the presentation device 2612 can include a remote client-computing device that communicates with the computing system 2600 via the network interface device 2610 using one or more data networks described herein.

While the present subject matter has been described in detail with respect to specific implementations thereof, it will be appreciated that those skilled in the art, upon attaining an understanding of the foregoing, may readily produce alterations to, variations of, and equivalents to such implementations. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Implementations of the methods disclosed herein may be performed in the operation of such computing devices. The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing some aspects of the present subject matter. Any suitable programming, scripting, or other type of language or combinations of languages may be used to implement the teachings contained herein in software to be used in programming or configuring a computing device. The order of the blocks presented in the examples above can be varied—for example, blocks can be re-ordered, combined, and/or broken into sub-blocks. Certain blocks or processes can be performed in parallel.

What is claimed is:

1. A computer-implemented method comprising:
identifying, by processing hardware, an input application code;
based on a scan of the input application code, determining, by the processing hardware, one or more data processing activity components within the input application code; and
determining, by the processing hardware, data categories for the one or more data processing activity components, wherein the data categories comprise data types or data processing purpose type corresponding to the one or more data processing activity components.

2. The computer-implemented method of claim 1, further comprising determining the one or more data processing activity components by identifying a data processing component reference within the input application code, wherein a data processing activity component comprises a software development kit (SDK) component, an application programming interface (API) component, or a function call component.

3. The computer-implemented method of claim 1, further comprising determining the one or more data processing activity components by matching a namespace from the input application code to a detector specification entry, within a detector specification, indicating pairings between one or more namespaces and one or more data processing components, wherein the detector specification entry comprises at least one of the namespace, a scanning identifier for the namespace, a data processing description for the namespace, a data type, or a functionality type.

4. The computer-implemented method of claim 1, further comprising determining the data categories for the one or more data processing activity components by:
identifying a data type corresponding to a data processing activity component from the one or more data processing activity components; and
utilizing the data type to assign the data processing activity component with a data category.

5. The computer-implemented method of claim 3, wherein the data type comprises wherein the data type comprises location data, cookie data, camera data, computing device data, demographic data, hit-level data, device usage data, or personal identifiable information data.

6. The computer-implemented method of claim 1, further comprising determining the data categories for the one or more data processing activity components by:
identifying a data processing purpose type corresponding to a data processing activity component from the one or more data processing activity components, wherein the data processing purpose type comprises utilization for application function, analytics, digital advertisement targeting, data aggregation, or debugging; and
utilizing the data processing purpose type to assign the data processing activity component with a data category.

7. The computer-implemented method of claim 1, further comprising determining the data categories for the one or more data processing activity components by determining a source for a data processing activity component, wherein the source comprises an owner entity or a developer for the data processing activity component.

8. The computer-implemented method of claim 1, further comprising determining the one or more data processing activity components from a call graph generated from the input application code, wherein the call graph comprises nodes indicating namespaces, class names, or method names within the input application code.

9. The computer-implemented method of claim 8, further comprising utilizing the call graph to assign a data processing activity component or a data category to a portion of the input application code.

10. The computer-implemented method of claim 1, further comprising generating a software profile for the input application code by:
assigning the data categories for the one or more data processing activity components to a first version of the input application code;
determining, from a second version of the input application code, additional data categories for additional data processing activity components; and
assigning the additional data categories for the additional data processing activity components to the second version of the input application code.

11. A non-transitory computer-readable medium storing executable instructions which, when executed by a processing device, cause the processing device to perform operations comprising:
identifying a set of detected data processing activity components within a first version of an input application code;
scanning a second version of the input application code to identify an additional set of detected data processing activity components within the second version of the input application code; and
determining data processing activity component modifications between the first version of the input application code and the second version of the input application code based on the set of detected data processing activity components and the additional set of detected data processing activity components.

12. The non-transitory computer-readable medium of claim 11, wherein the set of detected data processing activity components comprise software development kit (SDK) components, application programming interface (API) components, or function call components.

13. The non-transitory computer-readable medium of claim 11, wherein the operations further comprise determining the data processing activity component modifications between the first version of the input application code and the second version of the input application code by identifying an addition or removal of a data processing activity component between the set of detected data processing activity components and the additional set of detected data processing activity components.

14. The non-transitory computer-readable medium of claim 11, wherein the operations further comprise:
identifying a set of data categories for the set of detected data processing activity components, wherein a data category comprises a data type or data processing purpose type corresponding to one or more data processing components from the set of detected data processing activity components;
identifying an additional set of data categories for the additional set of detected data processing activity components; and
determining data category modifications between the first version of the input application code and the second version of the input application code based on the set of data categories and the additional set of data categories.

15. The non-transitory computer-readable medium of claim 14, wherein the operations further comprise determining the data category modifications between the first version of the input application code and the second version of the input application code by identifying an addition or removal of a data category between the set of data categories and the additional set of data categories.

16. The non-transitory computer-readable medium of claim 11, wherein the operations further comprise determining a number of added data processing activity components from the data processing activity component modifications.

17. A system comprising:
one or more non-transitory computer readable media; and
processing hardware configured to cause the system to:
identify an input application code;
based on a scan of the input application code, determine one or more data processing activity components within the input application code; and
determine data categories for the one or more data processing activity components, wherein the data categories comprise data types or data processing purpose type corresponding to the one or more data processing activity components.

18. The system of claim 17, wherein the processing hardware is configured to cause the system to determine the data categories for the one or more data processing activity components by:
identifying a data type corresponding to a data processing activity component from the one or more data processing activity components, wherein the data type comprises location data, cookie data, camera data, computing device data, demographic data, hit-level data, device usage data, or personal identifiable information data; and
utilizing the data type to assign the data processing activity component with a data category.

19. The system of claim 17, wherein the processing hardware is configured to cause the system to determine the data categories for the one or more data processing activity components by:
identifying a data processing purpose type corresponding to a data processing activity component from the one or more data processing activity components, where the data processing purpose type comprises utilization for application function, analytics, digital advertisement targeting, data aggregation, or debugging; and
utilizing the data processing purpose type to assign the data processing activity component with a data category.

20. The system of claim 17, wherein the processing hardware is configured to cause the system to determine data categories for the one or more data processing activity components by:
determining a first data category associated with a first set of data processing activity components from the one or more data processing activity components grouped by a first data type; and
determining a second data category associated with a second set of data processing activity components from the one or more data processing activity components grouped by a second data type.
